(19) United States
(12) Patent Application Publication
(10) Pub. No.: US 2025/0166061 A1
(43) Pub. Date: May 22, 2025

(54) DISTRIBUTED LEDGER-BASED SECURING OF SHARED COLLATERAL ASSETS

(71) Applicant: INTERNATIONAL BUSINESS MACHINES CORPORATION, Armonk, NY (US)

(72) Inventors: Krishnasuri Narayanam, Bangalore (IN); Venkatraman Ramakrishna, Bangalore (IN); Sandeep Nishad, Bangalore (IN); Dhinakaran Vinayagamurthy, Erode (IN); Sikhar Patranabis, Bangalore (IN); Vinayaka Pandit, Bangalore (IN)

(21) Appl. No.: 18/518,239

(22) Filed: Nov. 22, 2023

(51) Int. Cl. G06Q 40/03; G06Q 20/10; G06Q 20/38

(52) U.S. Cl. CPC G06Q 40/03; G06Q 20/102; G06Q 20/3827

(57) ABSTRACT

A computer-implemented method includes locking a shared digital collateral asset with a first hash for a first time period. The shared digital collateral asset is owned by a plurality of borrowers. The first hash is generated by hashing a plurality of secrets corresponding to the plurality of borrowers. The method includes locking a digital loan asset with the first hash for a second time period. The second time period is less than the first time period. The method includes releasing the digital loan asset to the plurality of borrowers in response to receiving a first secret preimage prior to expiration of the second time period. The first secret preimage is generated using the plurality of secrets. The method includes, prior to expiration of the first time period, claiming the shared digital collateral asset using the first secret preimage and pledging the shared digital collateral asset for a loan term.

### BACKGROUND

This disclosure relates to the field of distributed ledgers and interoperability among distributed ledgers. This disclosure further relates to digitally securing a shared collateral asset using one or more distributed ledgers.

A distributed ledger refers to a shared, immutable ledger that facilitates the process of recording transactions and tracking assets in a business network. In Web3 and decentralized finance (DeFi) systems, it is often the case that distributed ledgers are implemented to serve particular purposes leading to a proliferation in the number and type of digital ledgers. For example, some distributed ledgers may be dedicated to digital currency while other distributed ledgers are dedicated to financial instruments or digital assets. Further illustrating the proliferation of distributed ledgers, various central banks around the world have begun developing Central Bank Digital Currencies (CBDCs). A CBDC is a digital form of a country's fiat currency. A distributed ledger for a CBDC, for purposes of illustration, is often dedicated to managing that CBDC.

Given the ever-growing number and variety of distributed ledgers, it is often the case that a given transaction involves communicating between multiple, different distributed ledgers. Facilitating transactions across different distributed ledgers, however, presents various technical challenges. To continue supporting decentralized financial systems, technical challenges relating to distributed ledger interoperability such as providing coordination and atomicity across independent ledgers must be addressed. Further technical challenges relate to supporting more complex transactions such as commercial transactions and/or inter-party and/or multi-party transactions that span longer periods of time compared to more straight forward two-party asset exchanges.

### SUMMARY

In one or more embodiments, a computer-implemented method for automatically and digitally securing an asset is disclosed. The method includes locking a shared digital collateral asset with a first hash for a first predetermined time period. The shared digital collateral asset is owned by a plurality of borrowers. The first hash is generated by hashing a plurality of secrets corresponding to the plurality of borrowers. The method includes locking a digital loan asset with the first hash for a second predetermined time period. The second predetermined time period is less than the first predetermined time period. The method includes releasing the digital loan asset to the plurality of borrowers in response to receiving a first secret preimage prior to expiration of the second predetermined time period. The first secret preimage is generated using the plurality of secrets. The method includes, prior to expiration of the first predetermined time period, claiming the shared digital collateral asset using the first secret preimage and pledging the shared digital collateral asset for a loan term.

In one or more example implementations, a system includes one or more hardware processors, e.g., computer hardware, configured (e.g., programmed) to execute operations as described within this disclosure.

In one or more example implementations, a computer program product includes one or more computer readable storage mediums having program instructions embodied therewith. The program instructions are executable by computer hardware, e.g., one or more hardware processors, to cause the computer hardware to initiate and/or execute operations as described within this disclosure.

### BRIEF DESCRIPTION OF DRAWINGS

FIG. 1 illustrates a computing environment executing a shared collateral asset transaction (SCAT) framework in accordance with one or more embodiments of the present invention.

FIGS. 2A and 2B illustrate an example blockchain architecture configuration and transactional flow between nodes in accordance with one or more embodiments of the present invention.

FIG. 3 is a functional block diagram of a shared collateral asset system suitable for operation of a shared collateral asset program in accordance with one or more embodiments of the present invention.

FIGS. 4A, 4B, and 4C are block flow diagrams depicting operations of multiple phases of a transaction as performed by a shared collateral asset program in accordance with one or more embodiments of the present invention.

FIGS. 5A, 5B, 5C, and 5D illustrate an example systems having a physical infrastructure configured to perform various operations in accordance with one or more embodiments of the present invention.

FIGS. 6A, 6B, 6C, and 6D illustrate various aspects of block chain operations in accordance with one or more embodiments of the present invention.

### DETAILED DESCRIPTION

This disclosure relates to the field of distributed ledgers and interoperability between distributed ledgers. This disclosure further relates to digitally securing a shared collateral asset using one or more distributed ledgers. A distributed ledger means a distributed database that is immutable and consensually shared and synchronized across multiple computing nodes. The computing nodes may be distributed across multiple sites, institutions, geographies, and/or accessed by multiple parties. A distributed ledger allows transactions to have public “witnesses.” A participant at each node of the network can access the recordings shared across that network and can own an identical copy of it. Any changes or additions made to the ledger are reflected and copied to all participants. A distributed ledger is capable of facilitating the process of recording transactions and tracking assets in a business network. An example of a distributed ledger is a blockchain.

In accordance with the inventive arrangements described within this disclosure, methods, systems, and computer program products are provided that address technical issues and requirements relating to the securing of shared collateral assets using distributed ledgers. The inventive arrangements may be used to facilitate various types of transactions using a distributed ledger or a plurality of distributed ledgers in which interoperability and/or communication is necessary. For example, when a borrower receives a loan from a lender, the lender may require a collateral asset to attach to the loan to ensure the lender receives repayment of the loan. In many cases, there may not be a single borrower on a loan, but rather a plurality of borrowers on the loan. In such cases, the collateral asset may be one that is shared or owned by the plurality of borrowers, referred to herein as the “borrowing entity.” That is, the collateral asset is one in which each borrower of the plurality of borrowers has an interest. In the event the borrowers do not pay back the loan and default on the loan, the loaner can keep the collateral asset. If the borrowers satisfy the loan, the borrowers can collect the collateral asset back.

Within decentralized computing systems involving one or more distributed ledgers, there is a need to ensure the collateral asset is not used or spent by the lender during the loan period in order to ensure that if the borrowers pay back the loan, the borrowers can recollect the mutually owned collateral asset. There is also a need to account for changes in ownership interests in the collateral asset over the life of the loan, which may be significantly longer than other more direct asset exchanges on a distributed ledger. There is a need to ensure that the loaner, despite changes in ownership interests in the collateral asset over the life of the loan, is paid back by the correct set of borrowers or is able to keep the collateral asset regardless of changing ownership interests in the collateral asset over the life the loan.

An asset can be tangible (a house, car, cash, land) or intangible (intellectual property, patents, copyrights, branding). A non-fungible token (NFT) is a record on a blockchain which is associated with a particular asset, whether digital or physical. The ownership of an NFT is recorded in the blockchain, and can be transferred by the owner, allowing NFTs to be sold and traded. A smart contact is a computer program or a transaction protocol that is intended to automatically execute, control or document legally relevant events and actions according to the terms of a contract or an agreement. For example, when an NFT is transferred from one cryptocurrency wallet to another, a smart contract attached to the NFT is executed. A cryptocurrency wallet is a device, physical medium, program or a service which stores digital assets for cryptocurrency transactions. Locking a digital asset on a distributed ledger ensures the asset cannot be traded, sold, or transferred to another cryptocurrency wallet or platform until the digital asset is unlocked.

A collateral asset is any asset a borrower uses to secure a loan from a lender. Meaning, if a borrower defaults on paying back the loan to the lender, the lender can secure or obtain the collateral asset as a form of repayment. Typically, repayment of a loan includes the loan amount plus interest over a set amount of time. A shared collateral asset is a collateral asset in which two or more borrowers have an interest or ownership interest.

Proof of Work (POW) is a computer-based process that uses a competitive validation method to confirm transactions and add new blocks to the blockchain. Proof of Work is a decentralized consensus mechanism that requires members of a network to expend effort solving an arbitrary mathematical puzzle to prevent anybody from gaming the system. Proof of work is used widely in cryptocurrency mining, for validating transactions and mining new tokens. Tokens are crypto assets that do not have their own blockchain but live on another blockchain and benefit from its technology. Tokens may be used, for example, in the case where information about a ledger must be supplied to a party that is not on the network of peers that maintains the distributed ledger. Proof of work needs to be supplied to convince a party of the authenticity of the information. The receiver of the information must be able to validate the proof against the supplied information without themselves joining the network. In an open network, where the chain of blocks can be obtained by anyone who seeks them, proof-of work or proof-of-stake can serve to fix this problem. Proof-of-stake is a cryptocurrency consensus mechanism designed to prevent fraud by paying users to vouch for the legitimacy of transactions.

A pledge of interest is a computer-based process by which holders of a particular token can receive a reward. Pledges of interest originate from a proof of interest mechanism used in distributed blockchain networks, where blockchain miners can mine or validate block transactions against their token holdings. Pledging refers to the operation(s) that record a commitment on a distributed ledger to transfer ownership of an asset to a different party, and possibly move that asset to a different distributed ledger altogether in the process. Pledging can only be made by the current legitimate owner of the asset. The act of pledging must be accompanied by proof showing that one is entitled to make a pledge. The receiver (on the same or on a different ledger) can claim this asset within a specified time period before the pledge expires by proving its credentials to the network (e.g., the smart contract governing the asset).

According to an aspect of the invention, there is provided a computer-implemented method for automatically and digitally securing an asset. The computer-implemented method can include locking a shared digital collateral asset with a first hash for a first predetermined time period. The shared digital collateral asset is owned by a plurality of borrowers. The first hash is generated by hashing a plurality of secrets corresponding to the plurality of borrowers. The computer-implemented method can include locking a digital loan asset with the first hash for a second predetermined time period. The second predetermined time period is less than the first predetermined time period. The computer-implemented method can include, prior to expiration of the first predetermined time period, claiming the shared digital collateral asset using the first secret preimage and pledging the shared digital collateral asset for a loan term.

The embodiments are capable of effectuating complex transactions, e.g., loans, that involve a plurality of different parties, including multiple borrowers, across one or more distributed ledgers. The embodiments provide a mechanism for conditional asset exchange over the one or more distributed ledgers. Referring to the foregoing example, the digital loan asset and the shared digital collateral asset may reside on different distributed ledgers requiring communication between the two distributed ledgers. In many cases, a complex transaction involves multiple different phases and may span days, weeks, months, or years. Available distributed ledger technologies such as Hashed Time Lock Contracts (HTLCs) are suitable for atomic swaps, but are unable to handle complex, multi-phase transactions. An HTLC is a type of smart contract used in blockchain applications. The atomic swaps facilitated by an HTLC, for example, still must be sequenced in a safe and interlinked manner that protects the parties involved. Multi-Party HTLCs (MPHTLCs) are similarly suited for a one time-limited swap and may not be extended to handle more complex transactions described herein that involve multiple related swaps occurring asynchronously over longer periods of time.

The embodiments provide a technical effect that includes implementing the coordination and atomicity necessary (e.g., sequencing and interlinking to achieve a defined or desired/allowable set of outcomes) among one or more distributed ledgers to implement a complex transaction. The embodiments utilize, at least in part, the multiple predetermined periods of time, time-based conditions, hashes involving secrets from multiple borrowers, and the secret preimage also generated using the secrets of multiple borrowers to achieve the technical effect. For example, items such as the shared digital collateral asset and the digital loan asset are locked to prevent the items from being subject to other transactions that may defeat the loan operation conducted over the multiple ledgers. The digital loan asset is locked using the first hash generated using a secret from each borrower of the plurality of borrowers thereby ensuring that each borrower is involved in the locking process. The digital loan asset is obtained by the plurality of borrowers using the first secret preimage, which is generated using the same secrets of the plurality of borrowers used to generate the first hash. The time constraints ensure a timely resolution to the exchanges of the shared digital collateral asset and the digital loan asset. The embodiments ensure that, despite the complexity and duration of the transaction, borrowers are not cheated out of money or collateral and the lender may be repaid in accordance with the loan terms or obtain the shared collateral asset in the event the loan is not repaid in accordance with the loan terms.

In embodiments, the computer-implemented method optionally includes transferring an interest in the shared digital collateral asset from a first borrower of the plurality of borrowers to a transferee. The transferring can include, locking, for a third predetermined time period, a digital payment asset of the transferee using a second hash. The second hash is generated using a second secret preimage from the first borrower. The third predetermined time period is less than a remaining portion of the loan term. The transferring can include locking a pledge state of the shared digital collateral asset using the second hash. The transferring can include claiming, for the first borrower, the digital payment asset using the second hash prior to expiration of the third predetermined time period. The transferring can include claiming, for the transferee, the pledge state on the shared digital collateral asset using the second secret preimage. The first borrower is replaced with the transferee in the plurality of borrowers.

The embodiments provide a technical effect that includes establishing interoperability among one or more distributed ledgers to ensure that, despite the complexity and duration of the transaction, loan obligations optionally may be transferred to different parties. A digital payment asset is made available to an existing borrower from the transferee to replace that borrower with the transferee. In the example, the digital payment asset to be provided to the first borrower from the transferee is secured with a second hash. The pledge state of the secure digital collateral asset also is locked with the second hash and subsequently claimed using the second secret preimage used to generate the second hash. The embodiments are capable of ensuring that any changes in ownership interest(s) in the secure digital collateral asset are properly recorded in the appropriate distributed ledger(s) by ensuring interoperability and communication among the distributed ledgers. As such, the lender may be repaid in accordance with the loan terms or obtain the secure digital collateral asset in the event the loan is not repaid despite any changes in the ownership interests of the secure digital collateral asset that may occur over the course of the loan.

In embodiments, the computer-implemented method optionally includes a process for fulfilling the loan. The embodiments provide a technical effect that includes ledger interoperability to ensure that obligations and interests in digital items are accurately reflected in the respective distributed ledgers. This process accounts for the possibility that interest(s) in the secure digital collateral asset may have changed over the loan term by implementing an atomic sale of debt obligation via the one or more distributed ledgers. For example, the method can include pledging a digital repayment asset for an amount of time that exceeds the loan term. The method can include claiming the shared digital collateral asset by obtaining proof of the pledging of the digital repayment asset and providing the proof prior to expiration of the loan term. The method can include claiming the digital repayment asset by providing proof the claim on the shared digital collateral asset prior to expiration of a fourth predetermined time period.

The embodiments provide a technical effect that includes coordinating operation among multiple borrowers and/or coordinating operation of multiple distributed ledgers to interoperability and accurate communication thereby ensuring that the digital items and communications are provided to and receive from the correct entities. The embodiments ensure, for example, that the digital repayment asset is provided to the lender. The embodiments utilize proof of work principles in relation to pledging and any claims to ensure that each party to the transaction receives what is due per the loan terms. The embodiments provide interoperability through cross-ledger data sharing with proof of distributed ledger state authenticity. The procedures further account for the possibility that interest(s) in the shared collateral asset may have changed over the loan period.

In embodiments, the computer-implemented method optionally includes a process for fulfilling the loan. The process may be used for cases in which interest(s) in the shared collateral asset have not changed over the loan period. For example, the method can include pledging a digital repayment asset for an amount of time that exceeds the loan term. The method can include claiming the shared digital collateral asset by obtaining proof of the pledging of the digital repayment asset and providing the proof prior to expiration of the loan term. The method can include claiming the digital repayment asset by providing proof the claim on the shared digital collateral asset prior to expiration of a fourth predetermined time period.

The embodiments provide a technical effect that includes coordinating operation among multiple borrowers and/or coordinating operation of multiple distributed ledgers to interoperability and accurate communication thereby ensuring that the digital items and communications are provided to and receive from the correct entities. The embodiments are capable of coordinating operation among multiple borrowers and/or coordinating operation of multiple distributed ledgers to ensure that the digital repayment asset is provided to the lender. The embodiments utilize proof of work principles in relation to pledging and any claims to ensure that each party to the transaction receives what is due per the loan terms. The embodiments provide interoperability through cross-ledger data sharing with proof of distributed ledger state authenticity.

In embodiments, optionally, the digital loan asset is maintained in a first distributed ledger and the shared digital collateral asset is maintained in a second distributed ledger. In embodiments, the digital repayment asset provided prior to expiration of the loan term is optionally maintained in a third distributed ledger. The embodiments provide a technical effect that includes providing interoperability and accurate, trusted communication among a plurality of distributed ledgers. As noted, the cross-ledger sharing, proof of distributed ledger authenticity, and atomicity ensure that the various operations of the transaction may be performed regardless of the involvement of multiple different distributed ledgers used for different purposes.

In embodiments, the computer-implemented method optionally includes, in response to expiration of the loan term, the shared digital collateral asset is automatically freed from the pledging. The embodiments provide a technical effect that includes tracking state changes with respect to the shared digital collateral asset over extended periods of time potentially across multiple different distribute ledgers. The embodiments ensure that the shared digital collateral asset is freed regardless of any changes in interests in the shared digital collateral asset over the loan period and regardless of involvement of different distributed ledgers in this phase of the transaction.

In one or more embodiments, the borrowers are guaranteed to recover the shared digital collateral asset immediately upon repayment of the loan with interest. Embodiments of the present invention prevent the shared digital collateral asset from being spent or used by the lender until the loan period elapses, and the borrowers have not repaid the loan amount with interest within the agreed loan period.

In one or more embodiments, borrowers may repay a loan back early to a lender before the loan period expires. Embodiments of the present invention automatically unlock the shared digital collateral asset for the borrowers to recover upon repayment or satisfaction of the loan. Embodiments of the present invention automatically unlock the shared digital collateral asset for the borrowers upon repayment of the loan. Meaning, if the borrowers repay the loan back early, the borrowers gain back access to their shared digital collateral asset earlier and do not need to wait for the loan period to expire.

In one or more embodiments, the borrowers are assured to receive the digital loan asset at the beginning of the loan tenure. Embodiments of the present invention distribute the digital loan asset to the borrowers at the beginning of the loan tenure. Embodiments of the present invention allow the borrowers to recover the shared digital collateral asset anytime within the loan term by paying the loan amount or satisfying the loan to the lender. In an embodiment, the amount to satisfy the loan is more than the amount borrowed. For example, the digital loan asset has an interest and the amount to satisfy the loan is the digital loan asset (e.g., amount) plus the interest over time of the loan amount borrowed. If the borrowers do not satisfy the loan before the loan term time expires, embodiments of the present invention unlock the shared digital collateral asset for the lender.

The embodiments provide a technical effect that includes transferring the digital loan asset (e.g., the loan amount) and locking a shared digital collateral asset owned by multiple borrowers in a singular transaction. The embodiments provide a further technical effect that includes distributing loan amounts and locking a shared digital collateral asset in a singular transaction. Further, embodiments of the present invention recognize the need to unlock the shared digital collateral asset in response to receipt of the digital repayment asset in a singular transaction.

From time-to-time within this disclosure, assets such as the digital loan asset, the digital repayment asset, and the like may be referred to in terms of amounts. For example, the term “loan amount” may be used in place of the term “digital loan asset.” As another example, the term “repayment amount” may be used in place of the term “digital repayment asset.”

The inventive arrangements effectuate the transactions described herein using distributed ledger(s) (e.g., blockchain(s)) and smart contracts. Embodiments of the present invention recognize the need to solve the problem of communicating between distributed ledgers for authenticity proof, automatically swapping digital assets, and transferring digital assets from one distributed ledger to another all while not compromising the safety and authenticity of the transferred digital assets and information. For example, using one or more distributed ledgers allows a loan to issue in one currency and repayment of the loan in another currency. Embodiments of the present invention solve the problem of utilizing multiple ledgers by sending details of the pledge or proofs and claim on a digital asset on a first distributed ledger in a first network to a second distributed ledger that may be in a second network. Embodiments of the present invention recognize the need for utilizing different distributed ledgers. Embodiments of the present invention recognize sensitive financial assets are typically maintained on private networks. Embodiments of the present invention utilize pledges and proofs to ensure the authenticity of the work on different distributed ledgers. In an embodiment a pledge is secured data from one blockchain to another. In an embodiment, the proof is proof of work in a blockchain which conveys the off-ledger proof is authentic.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

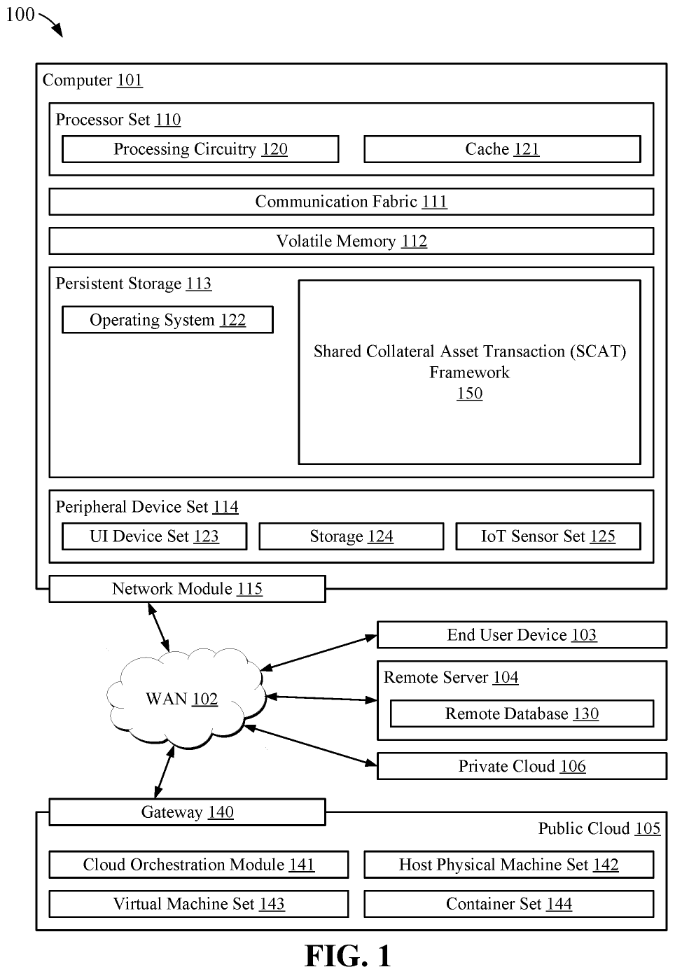

Referring to FIG. 1, computing environment 100 contains an example of an environment for the execution of at least some of the computer code involved in performing the inventive methods, such as shared collateral asset transaction (SCAT) framework 150. SCAT framework 150 is executable by computer 101 to perform various operations described herein that facilitate interoperability among one or more distributed ledgers to implement complex transactions involving multiple parties that may include multiple borrowers. In the examples, each of the multiple borrowers has an ownership interest in a shared digital collateral asset used to obtain a loan from a lender. SCAT framework 150 is executable to, among other things, ensure that the lender is repaid in accordance with the loan terms or, in the event of a default, obtains the shared digital collateral asset regardless of any changes in ownership interest in the shared digital collateral over the life of the loan. SCAT framework 150 further is operable to effectuate changes in ownership interest in the shared digital collateral asset over the life of the loan. In addition to SCAT framework 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and SCAT framework 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in SCAT framework 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in SCAT framework 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

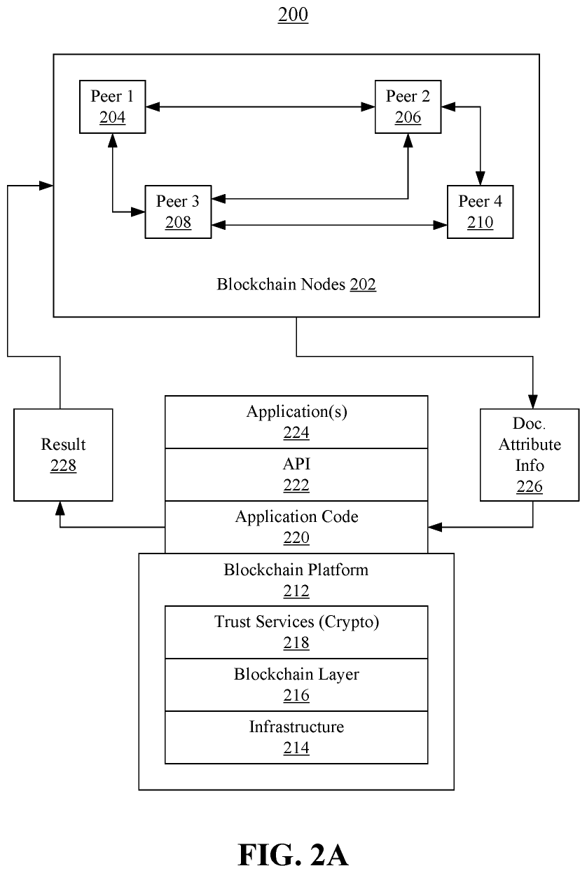

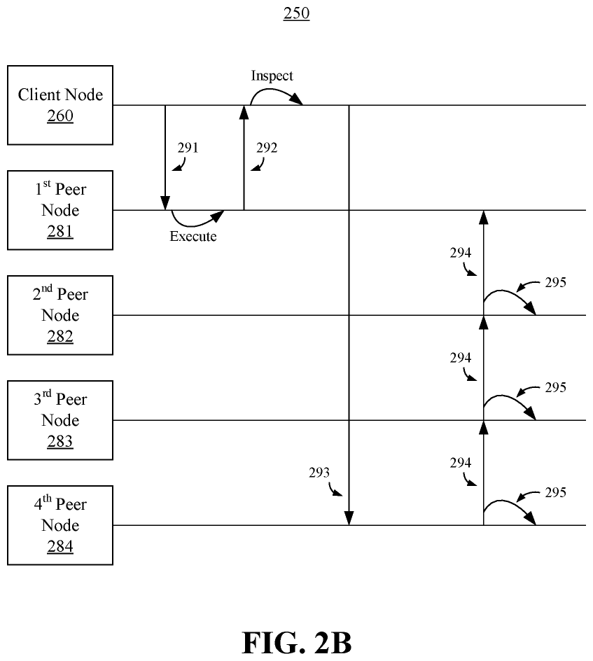

FIG. 2A illustrates an example blockchain architecture 200, according to one or more embodiments of the present invention. Referring to FIG. 2A, the blockchain architecture 200 may include certain blockchain elements, for example, a group of blockchain nodes 202. The blockchain nodes 202 may include one or more nodes 204, 206, 208, and 210 (these four nodes are depicted by example only). These nodes participate in a number of activities, such as blockchain transaction addition and validation process(es) typically referred to as “consensus.” A blockchain node may initiate a blockchain authentication and seek to write to a blockchain immutable ledger stored in blockchain layer 216, a copy of which may also be stored on the underpinning physical infrastructure 214. The blockchain architecture 200 may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. Application code 220 may control blockchain assets. For example, application code 220 can store and transfer data, and may be executed by nodes 204-210 in the form of a smart contract and associated chaincode with conditions or other code elements subject to its execution. As a non-limiting example, smart contracts may be created to execute the generation of storage spaces, the reserving of storage spaces, updates to current transaction agreements, etc. The smart contracts can themselves be used to identify rules associated with authorization and access requirements and usage of the distributed ledger. For example, the document attribute(s) information 226 may be processed by one or more processing entities (e.g., virtual machines) included in the blockchain layer 216. The result 228 may include a plurality of linked shared documents (e.g., with each linked shared document recording the issuance of a smart contract, etc.). The physical infrastructure 214 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details (e.g., thus establishing a new smart contract between a user and a licensor).

FIG. 2B illustrates an example of a blockchain transactional flow 250 between nodes of the blockchain according to one or more embodiments of the present invention. Referring to FIG. 2B, the transaction flow may include a transaction proposal 291 sent by an application client node 260 to an endorsing peer node 281 (e.g., in some embodiments, the transaction proposal 291 may be sent for determining licensing terms, ownership, or authentication of a digital asset). The endorsing peer node 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the application client node 260 along with an endorsement signature, if approved. The application client node 260 assembles the endorsements into a transaction payload and broadcasts it to an ordering service node 284. The ordering service node 284 then delivers ordered transactions as blocks to all peers 281, 282, and 283 on a channel. Before committal to the blockchain, each peer 281-283 may validate the transaction. For example, the peers may check the transaction terms, ownership, or other digital asset data to ensure correct allotment and distribution of assets for transaction payload.

Referring again to FIG. 2B, the client node 260 initiates the transaction proposal 291 by constructing and sending a request to the peer node 281, which is an endorser. The application client node 260 may include an application leveraging a supported software development kit (SDK), which utilizes an available API to generate a transaction proposal. The proposal is a request to invoke a chaincode function so that data can be read and/or written to the ledger (e.g., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (application client node 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the application client node 260 which parses the payload for the application to consume.

In response, the application of the application client node 260 inspects/verifies the endorsing peers signatures and compares the proposal responses to determine if the proposal response is the same. If the chaincode only queried the ledger, the application would inspect the query response and would typically not submit the transaction to the ordering service node 284. If the client application intends to submit the transaction to the ordering service node 284 to update the ledger, the application determines if the specified endorsement policy has been fulfilled before submitting (e.g., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the application client node 260 assembles endorsements into a transaction and broadcasts the transaction proposal and response within a transaction message to the ordering service node 284. The transaction may contain the read/write sets, the endorsing peers signatures and a channel ID. The ordering service node 284 does not need to inspect the entire content of a transaction to perform its operation, instead the ordering service node 284 may simply receive transactions from all channels in the network, order them chronologically by channel, and create blocks of transactions per channel.

The blocks of the transaction are delivered from the ordering service node 284 to all peer nodes 281-283 on the channel. The transaction 294 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 295 each peer node 281-283 appends the block to the channel's chain, and for each valid transaction the write sets are committed to the current state database. An event is emitted, to notify the client application that the transaction (invocation) has been immutably appended to the chain, as well as to notify whether the transaction was validated or invalidated.

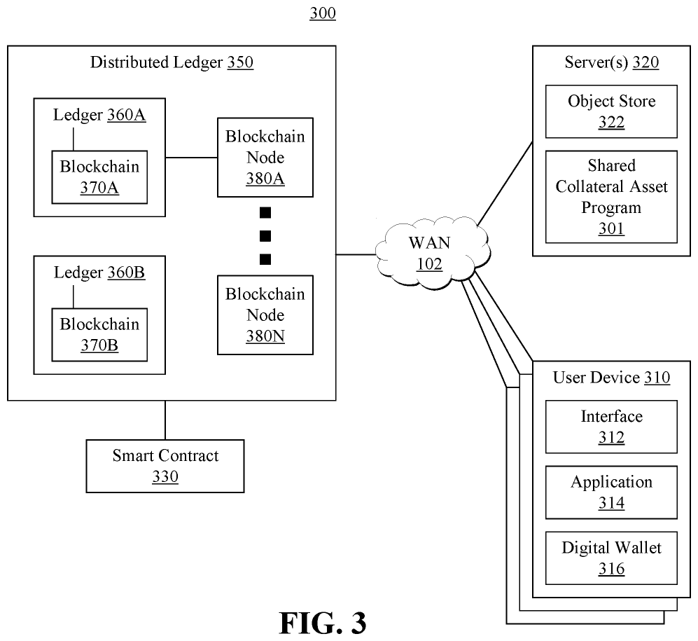

FIG. 3 is a functional block diagram of a shared collateral asset system 300 suitable for execution of a ledger transaction controller 301, in accordance with one or more embodiments of the present invention. In the example, ledger transaction controller 301 may be implemented as computer-readable program code (e.g., a computer program) that is executed by computer hardware as described herein. Shared collateral asset system 300 may be implemented in a computing environment, such as computing environment 100, as described with reference to FIG. 1. FIG. 3 provides an illustration of only one implementation and does not imply any limitations with regard to the environments in which different embodiments may be implemented. Many modifications to the depicted environment may be made by those skilled in the art without departing from the scope of the present invention as recited by the claims.

Shared collateral asset system 300 includes a plurality of user devices 310, server 320, smart contract 330, distrusted ledger 350, ledger 360A and 360B, blockchain 370A and 370B, blockchain nodes 380A-380N, interconnected over network, such as WAN 102. In general, each user device 310 can represent any programmable electronic device or combination of programmable electronic devices capable of executing machine readable program instructions and communicating with server 320 and other devices (not depicted) via a network, such as WAN 102. In an embodiment, each user device 310 is an end user device, such as EUD 103 depicted in FIG. 1, and can be a mobile device, laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art.

Each user device 310 further includes a user interface 312, an application 314, and a digital wallet 316. User interface 312 is a program that provides an interface between a user of an end user device, such as user device 310, and a plurality of applications that reside on the device (e.g., application 314). A user interface, such as user interface 312, refers to the information (such as graphic, text, and sound) that a program presents to a user, and the control sequences the user employs to control the program. A variety of types of user interfaces exist. In one embodiment, user interface 312 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 312 is a script or application programming interface (API).

Application 314 can be representative of one or more applications (e.g., an application suite) that operate on user device 310. In an embodiment, application 314 is representative of one or more applications (e.g., asset holding applications, asset marketplace applications, and asset authentication applications) located on user device 310. For example, a user accesses an asset holding software via application 314 to buy a digital asset. In another example, a user uploads a digital asset online via application 314. In various example embodiments, application 314 can be an application that a user of user device 310 utilizes to access an asset marketplace website and post for sale, trade, offer, or buy digital assets. In an embodiment, application 314 can be a client-side application associated with a server-side application running on server 320 (e.g., a client-side application associated with ledger transaction controller 301). In an embodiment, application 314 on each of the respective user devices 310 is capable of performing processing steps of ledger transaction controller 301 (i.e., application 314 can be representative of ledger transaction controller 301 operating on a respective user device 310).

Digital wallet 316 is a digital or cryptocurrency wallet. In an embodiment, digital wallet 316 includes information associated with one or more public and private keys corresponding to a digital asset. In an embodiment, digital wallet 316 includes information on one or more digital assets. In an embodiment, a digital asset includes an NFT, cryptocurrency, funds, or other digital assets. In an embodiment, digital wallet 316 is a hardware cryptocurrency wallet.

Server 320 is configured to provide resources to various computing devices, such as user devices 310. In general, server 320 represents any programmable electronic device or combination of programmable electronic devices capable of executing machine readable program instructions and communicating with each other, as well as with user devices 310, smart contract 330, and other computing devices (not shown) within a network, such as WAN 102. In an embodiment, server 320 is a standalone device, such as computer 101 depicted in FIG. 1, that is capable of running a program and accessing a network or querying a database. In an embodiment, server 320 can be a management server, a web server, an application server, a mobile device, or any other electronic device or computing system capable of receiving, sending, and processing data. In an embodiment, server 320 represents a server computing system utilizing multiple computers as a server system. In an embodiment, server 320 represents a computing system utilizing clustered computers and components (e.g., database server computer, application server computer, web server computer, webmail server computer, media server computer, etc.) that act as a single pool of seamless resources. Server 320 further includes ledger transaction controller 301 and object store 322. Ledger transaction controller 301 may be implemented as, or formed, at least in part, from SCAT framework 150 as depicted and described with reference to FIG. 1.

In an embodiment, object store 322 stores information on digital assets. In an embodiment, object store 322 is an object store service running on one or more servers.

In an embodiment, server 320 includes ledger transaction controller 301. In an embodiment, ledger transaction controller 301 may be configured to access various data sources, such as one or more digital wallets 316 of user devices 310, where the digital wallets 316 may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, ledger transaction controller 301 enables the authorized and secure processing of personal data. In an embodiment, ledger transaction controller 301 provides informed consent, with notice of the collection of personal data, allowing the user to opt in or opt out of processing personal data.

Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, ledger transaction controller 301 provides information regarding personal data and the nature (e.g., type, scope, purpose, duration, etc.) of the processing. In an embodiment, ledger transaction controller 301 provides a user with copies of stored personal data. In an embodiment, ledger transaction controller 301 allows for the correction or completion of incorrect or incomplete personal data. In an embodiment, ledger transaction controller 301 allows for the immediate deletion of personal data.

Smart contract 330 includes information on one or more smart contracts attached or associated with a digital asset. In an embodiment, smart contract 330 includes executable code which is registered, stored, and/or replicated with a blockchain. A transaction is an execution of the smart contract code which can be performed in response to conditions associated with the smart contract being satisfied, such as transferring an NFT from one cryptocurrency wallet to another. In an embodiment, smart contract 330 and a registry can be used interchangeably.

In an embodiment, smart contract 330 is written to the blockchain in the form of key-value pairs. Furthermore, the smart contract code can be structured to read the values stored in a blockchain and use them in application operations. The smart contract code can be structured to write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

In an embodiment, smart contract 330 is executed on blockchain nodes 380A-380N. In an embodiment, smart contract 330 determines the private key associated with the digital asset or wallet.

Distributed ledger 350 comprises one or more independent computers or nodes, such as ledger 360A and 360B and blockchain nodes 380A-380N, used to share and synchronize transactions in their respective electronic ledgers. In an embodiment, distributed ledger 350 is stored in a local blockchain, such as blockchain 370A and 370B.

Ledger 360A and 360B include one or more ledgers capable of executing a blockchain, such as blockchain 370A and 370B.

Blockchain 370 may be configured to use one or more smart contracts, such as smart contract 330, that manage transactions for multiple participating nodes. In some embodiments, a neural network and/or any form of machine-learning may be utilized by the cloud service providers to analyze the smart contracts and/or transaction requests to determine transaction terms or authenticating information. In an embodiment, blockchain 370A and 370B may store data to be shared among the nodes, such as blockchain nodes 380. In an embodiment, blockchain 370A and 370B may be represented by a configuration of blockchain architecture 200, as described with reference to FIG. 2A.

Blockchain nodes 380A-380N includes one or more nodes. In an embodiment, blockchain nodes 380A-380N may be represented by blockchain nodes 202, as previously described with reference to FIG. 2A.

In an embodiment, a transaction is initiated in which ledger transaction controller 301 receives a request that a plurality of users are borrowing a loan and are using a shared digital collateral asset to secure the loan. The transaction that is initiated is a complex transaction that includes multiple phases. Each of the borrowers has an interest, e.g., an ownership interest, in the shared digital collateral asset. For purposes of illustration, the borrowers include user X and user W. For example, ledger transaction controller 301 receives a request from user X and user W, e.g., from their respective user devices 310 executing respective applications 314, to borrow a loan from a lender Y. The loan request may be from one borrow with the consent of each other borrower. The loan request from users X and W further specifies that the loan is to be secured by a shared digital collateral asset M as the collateral for the loan. The shared digital collateral asset M in this example is owned jointly by user X and user W. The shared digital collateral asset M, for example, may be a bond. In an embodiment, ledger transaction controller 301 determines the loan term L (e.g., the life of the loan). In an embodiment, the loan term L is the amount of time the borrowers have to repay back or satisfy the loan. In an embodiment, to satisfy the loan, the borrowers must pay back the original loan amount and interest, referred to herein as the digital repayment asset R.

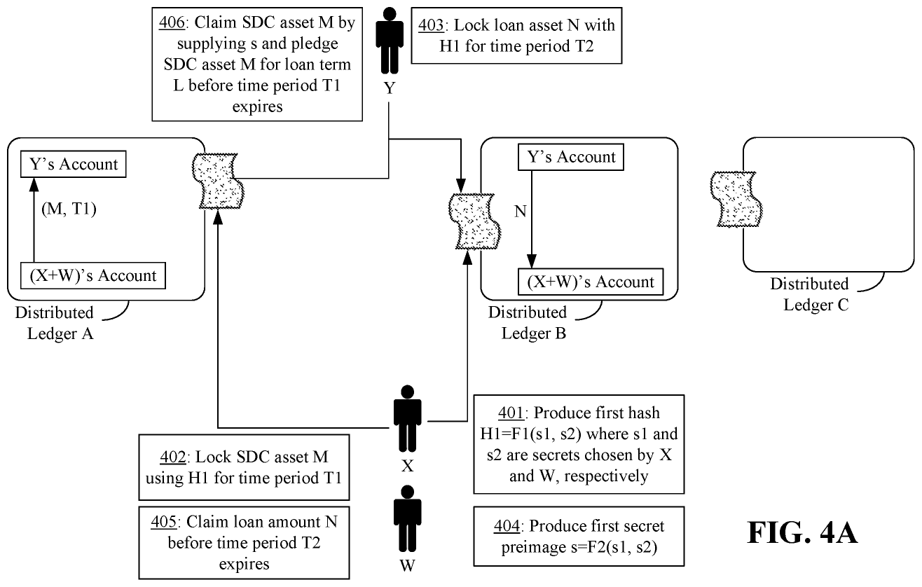

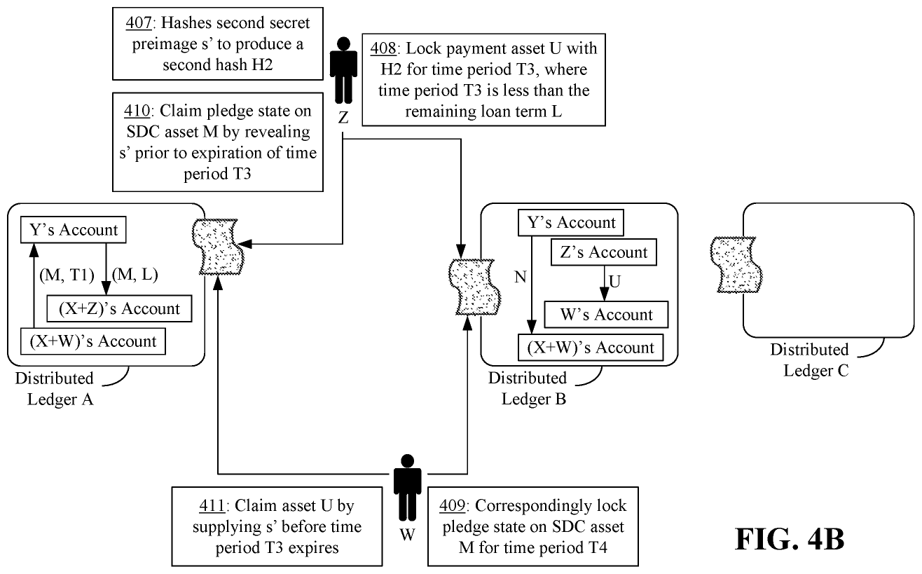

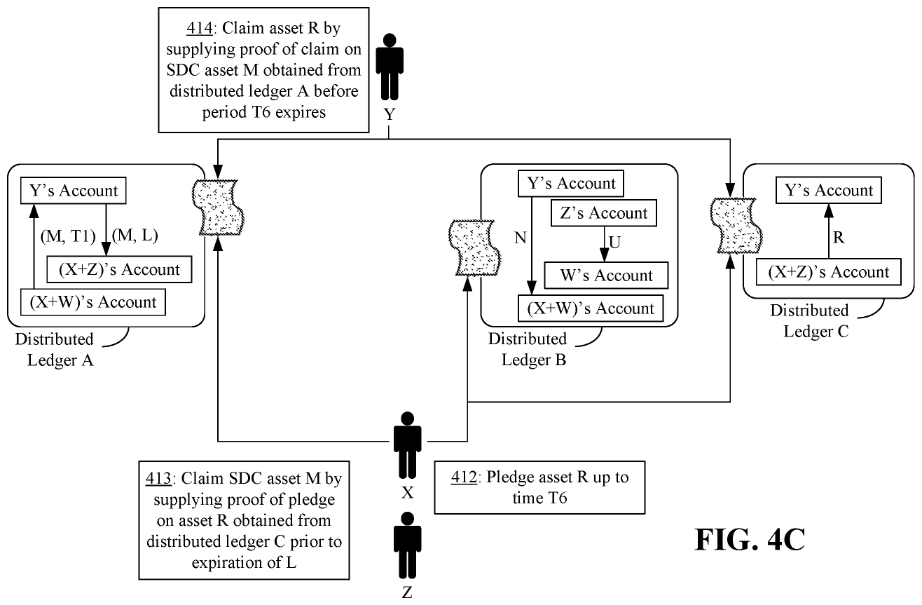

FIGS. 4A, 4B, and 4C, collectively referred to as FIG. 4, illustrate different phases of a complex transaction conducted using a plurality of distributed ledgers. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims. FIG. 4 depicts a plurality of network/ledgers. In the example, three distributed ledgers A, B, and C are illustrated. In other embodiments, fewer distributed ledgers (e.g., two) may be used while in still other embodiments, more than three distributed ledgers may be used. Any number of additional ledgers may be contemplated.

Regarding FIG. 4, it should be appreciated that certain operations described as being performed by a user are performed by the user device of the user. Further, such operations may include providing requests to ledger transaction controller 301, receiving responses from ledger transaction controller 301, and/or ledger transaction controller 301 otherwise communicating with user devices and/or distributed ledgers to implement and coordinate the operations of the complex transaction described. In this regard, the operations of FIG. 4 as described and as defined within this disclosure may not be performed by a human being, but rather are computer-based and distributed ledger-based operations. For example, certain operations such as locks, claims, and/or pledges may be implemented as primitive operations supported by blockchain platforms and may be initiated by a blockchain smart contract regardless of the particular implementation details of that smart contract.

FIG. 4A is a block flow diagram depicting operations of a first phase of a transaction as performed by ledger transaction controller 301 in accordance with one or more embodiments of the present invention. FIG. 4A illustrates an example of a conditional asset exchange implemented by ledger transaction controller 301 across one or more distributed ledgers. As discussed, in an embodiment, ledger transaction controller 301 may be implemented as, or as part of, SCAT framework 150 of FIG. 1.

In one or more embodiments, the first phase illustrated in FIG. 4A may be implemented using an MPHTLC (e.g., a first MPHTLC) that provides conditional ownership for the time period of the loan term L. The MPHTLC may impose conditional ownership referred to hereinbelow as “locks” or “locking” for a given digital asset involved in the transaction. In general, an HTLC enables atomic cross-chain swap of assets for tokens on a token network between two parties. The MPHTLC is capable of achieving the same albeit in cases where assets or tokens may not be owned solely by individuals, but rather co-owned by a group of individuals. The MPHTLC ensures safety for a co-owner against any possible attack launched by the collusion of a subset of co-owners of that asset.

Locking a digital asset means that ownership is conditional to meeting the conditions defined in the MPHTLC with the conditions being recorded or otherwise stored in one or more of the distributed ledgers. With respect to distributed legers, a lock on an asset may be implemented as a smart contract operation that prevents availability of the asset for any other transaction until either a subsequent claim on the asset occurs or the lock period expires thereby automatically unlocking the asset. Upon the occurrence of either condition (subsequent claim or lock period expiration), the asset state on the distributed ledger is updated by the corresponding claim/unlock smart contract.

FIG. 4A illustrates operations that implement a conditional atomic asset exchange for the lender to transfer the loan amount (e.g., the digital loan asset N) to the borrowers and for the borrowers to transfer the shared digital collateral asset M to the lender with the condition that the lender cannot spend the shared digital collateral asset M until expiration of the loan term. The conditional atomic asset exchange illustrated in FIG. 4A implements an MPHTLC that specifies conditional ownership thereby preventing a subset of borrowers from unilaterally transferring ownership of the shared digital collateral asset M to the lender.

In block 401, ledger transaction controller 301 produces a first hash H1. The first hash H1 is generated using a function F1 of a secret provided from each of the borrowers to ledger transaction controller 301. For example, the first hash H1 may be defined as H1=F1(s1, s2), where user X provides secret s1 to ledger transaction controller 301 and user W provides secret s2 to ledger transaction controller 301. In this example, each borrower provides their own secret to ledger transaction controller 301 and the first hash H1 is generated by ledger transaction controller 301 as a function of the secret provided from each respective borrower. In the example, the secret s1 chosen by user X is not known to user W, and the secret s2 chosen by user W is not known to user X. Further, the preimage for H1 may be computed using the secrets from users X and W and is not revealed to either user X or user W.

In block 402, ledger transaction controller 301 locks the shared digital collateral asset M with the first hash H1 for a time period T1 (e.g., a first predetermined time period). The shared digital collateral asset M is owned by a plurality of borrowers also referred to as the borrowing entity. In FIGS. 4A, 4B, and 4C, the shared digital collateral asset M is denoted as “SDC asset M.” As noted, the first hash H1 is generated by hashing a plurality of secrets corresponding to the plurality of borrowers. In this example, the plurality of borrowers includes user X and user W. In an embodiment, ledger transaction controller 301 locks the shared digital collateral asset M in response to a request received from user X that is paired with, e.g., accompanied by, consent provided from user W. In the example, the shared digital collateral asset M is locked using the first hash H1, which includes a secret from each borrow, to secure the lock to prevent any other claims on the shared digital collateral asset M. The lock placed on the shared digital collateral asset M may be placed by ledger transaction controller 301 in the distributed ledger A. As noted, the lock is placed using the first hash H1 generated using secrets from both (e.g., all) borrowers, which requires participation from all borrowers to generate the hash. Further, the lock is placed at the request of a borrower with the consent of each other borrower again requiring participation of all borrowers.

The time period T1 is used in the MPHTLC for locking the collateral asset M with hash H1 by users W and X. The computation of H1 using secrets from users X and W may be implemented in accordance with a cryptographic multi-party computation protocol that typically resides outside of the asset and token ledgers. Thus, shared digital collateral asset M is not available for any other transaction until either the time period T1 expires or user Y claims ownership on shared digital collateral asset M by supplying the pre-image for hash H1 used in the lock. Upon the occurrence of either of these conditions the asset state on the ledger is updated by the smart contract. If user Y does not provide the hash pre-image and period T1 expires, then the asset is moved back to the account of user's X and W by the smart contract automatically.

In an embodiment, the time period T1 is any amount of time less than the loan term L. The loan term L is typically in the order of one or more days, one or more months, or one or more years. Time period T1 is a small duration (e.g., few hours to days) within which either user Y or the borrowing entity needs to complete their actions such as locking, pledging, or claiming, each being executed on the relevant distributed ledger(s). For example, if the loan term L is three months, ledger transaction controller 301 locks the shared digital collateral asset M with the first hash H1 for three months. In an embodiment, ledger transaction controller 301 transfers information of the locked shared digital collateral asset M with H1 for the time period T1 from the borrowing entity to a first network or first ledger (e.g., distributed ledger A).

In an embodiment, ledger transaction controller 301 locks the shared digital collateral asset with the first hash H1 for the loan term L on a bond ledger. In an embodiment, a bond ledger, e.g., distributed ledger A, is a ledger that holds a digital representation or record of a physical bond. In an embodiment a bond ledger can be implemented on blockchain technology. In an embodiment, the bond ledger is a smart contract, such as smart contract 330 which executes the terms of a contract.

In block 403, ledger transaction controller 301 locks the digital loan asset N with the first hash H1 for a time period T2 (e.g., a second predetermined time period). In block 403, the first hash H1, as used to lock the shared digital collateral asset M, has become publicly known. In an embodiment, the time period T2 is less than the time period T1. In an embodiment, time period T2 may be equal to one-half the time period T1.

In an embodiment, in block 403, in response to the lock being placed on the shared digital collateral asset M in block 402, ledger transaction controller 301 locks the digital loan asset N using the first hash H1. In this example, the digital loan asset N (e.g., the amount to be loaned) is owned by user Y, where user Y is the lender (also referred to herein as “lender Y”). In an embodiment, in consequence of block 402, the first hash H1 is publicly known such that lender Y includes the first hash H1 in a lock request provided to ledger transaction controller 301 to effectuate the locking of the digital loan asset N. In an embodiment, ledger transaction controller 301 locks the digital loan asset N with the first hash H1 for a short duration, e.g., T2, on a token ledger.

In block 404, ledger transaction controller 301 produces a first secret preimage s. Ledger transaction controller 301 generates the first secret preimage s according to a function F2 where s=F2(s1, s2). In an embodiment, user X requests the generation of the first secret preimage s by ledger transaction controller 301 using s1 and s2. User W may provide consent for generating the first secret preimage s using s2 by ledger transaction controller 301. For example, ledger transaction controller 301 may query user W for permission to use s2 to generate the first secret preimage s responsive to the request from user X.

In block 405, ledger transaction controller 301 releases the digital loan asset N to the plurality of borrowers in response to receiving the first secret preimage s prior to expiration of the time period T2. As noted, the first secret preimage s is generated using the plurality of secrets (e.g., s1 and s2). For example, ledger transaction controller 301 claims the digital loan asset N on behalf of the plurality of borrowers prior to expiration of the time period T2. Ledger transaction controller 301 may claim the digital loan asset N on behalf of user X by revealing the first secret preimage s to distributed ledger A prior to expiration of the time period T2. In the example of FIG. 4A, the digital loan asset N is provided to user X's and user W's account through distributed ledger B. In an embodiment, ledger transaction controller 301 distributes the loan amount N to the borrowing entity.

In an embodiment, ledger transaction controller 301 transfers information of the first secret preimage s to claim the digital loan asset N before the time period T2 expires. In this example, time period T2 is the amount of time for which the digital loan asset N is locked. The digital loan asset N may be locked in a second network or a second ledger for the borrowing entity. As shown, digital loan asset N is released to an account of user X and user W via distributed ledger B.

In block 406, prior to expiration of the time period T1, ledger transaction controller 301 claims the shared digital collateral asset M using the first secret preimage s and pledges the shared digital collateral asset M for the loan term L. For example, ledger transaction controller 301 claims the shared digital collateral asset M on behalf of lender Y. The shared digital collateral asset M may be claimed by supplying the first secret preimage s and pledging the shared digital collateral asset M for the loan term L before the expiration of the time period T1. The shared digital collateral asset M is claimed by the lender Y through distributed ledger A. In an embodiment, ledger transaction controller 301 transfers the first secret preimage s to claim shared digital collateral asset M and pledges the shared digital collateral asset M for the loan term L before time period T1 expires from the distributed ledger A to the lender Y. That is, in the example, the digital loan asset N is maintained in a first distributed ledger and the shared digital collateral asset M is maintained in a second (e.g., and different) distributed ledger.

In an embodiment, ledger transaction controller 301 claims the shared digital collateral asset M using the first secret preimage s and pledges the shared digital collateral asset M as collateral for the loan term L on the bond ledger. In an embodiment a token ledger is a ledger implemented on a blockchain that holds digital representations of physical tokens. In an embodiment, tokens can include currency equivalents or non-fungible tokens (NFTs). In an embodiment, tokens are crypto assets that do not have their own blockchain but live on another blockchain and benefit from its technology. In an embodiment, the claiming of the shared digital collateral asset M and the pledging thereof in block 406 happen atomically.

After completion of the first phase of the complex transaction, the loan amount N is transferred to users X and W in distributed ledger B. The shared digital collateral asset M is provided to lender Y with conditions attached thereto via distributed ledger A. The conditions, e.g., the lock in distributed ledger A, prevents lender Y from spending the shared digital collateral asset M until the loan term L ends. In one or more embodiments, an MPHTLC may be used that incorporates conditional ownership for a particular period such as the loan term L.

FIG. 4B is another block flow diagram depicting the operations of a second phase of the complex transaction as performed by ledger transaction controller 301 in accordance with one or more embodiments of the present invention. The second phase of the complex transaction entails implementing an atomic sale of debt by user W to user Z involving operations conducted across multiple distributed ledgers. FIG. 4B illustrates the case where one of the original borrowers, e.g., user W also referred to herein as the first borrower, wishes to exit the loan and transfer their ownership interest in the shared digital collateral asset M to a transferee, e.g., user Z. This entails replacing user W as a borrower on the loan with user Z, which affects the source of any repayment of the loan and loss of the shared digital collateral asset in the event of a default on the loan.

In one or more embodiments, FIG. 4B is optional. That is, the ownership of the debt (e.g., the loan) and the underlying shared digital collateral asset M used as collateral may not change over the loan term L such that the original borrowers user X and user W remain the borrowers on the loan for the entirety of the loan term L. In one or more other embodiments, not only may the ownership of the debt (e.g., the loan) and the underlying shared digital collateral asset M change over the loan term, but the ownership may change multiple times between a variety of different parties. By the end of the loan term, there may be one or more original borrowers remaining or no original borrowers remaining. In this regard, the operations of FIG. 4B may be performed more than one time, e.g., implemented one time for each transfer of ownership throughout the loan term L.

FIG. 4B illustrates an example implementation of an atomic sale of a debt obligation that transfers obligations of a subset including one or more of the borrowers of the borrowing entity on the shared digital collateral asset M to a new set of one or more borrowers. The atomic sale of the debt obligation implements another MPHTLC to update intermediate ledger states representing obligations on the shared digital collateral asset M that are created as part of the conditional atomic asset exchange of FIG. 4A. In the interim, before the end of the loan term L, ledger transaction controller 301 is capable of freezing the shared digital collateral asset M from any state change or from being transferred during the transfer of the debt obligation from one set of co-owners to another. This ensures that no party involved in the loan is cheated by attacks launched by other borrowers colluding with the lender. Thus, in an embodiment, one or more existing borrowers may get updated with one or more new borrowers in a single transaction.

In block 407, ledger transaction controller 301 hashes a second secret preimage s′ to produce a second hash H2. In block 407, the secret preimage s′ is known only to user Z. In an embodiment, ledger transaction controller 301 generates the second hash H2 as H2=Hash(s′) in response to a request from user Z.

In block 408, ledger transaction controller 301 locks, for a time period T3 (e.g., a third predetermined time period), a digital payment asset U of the transferee using the second hash H2. The digital payment asset U is the amount being paid by user Z to acquire the interest of user W in the shared digital collateral asset M and replace user W as a borrower on the loan. As noted, the second hash H2 is generated using a second secret preimage s′ from the first borrower (e.g., user W). Further, the time period T3 is less than a remaining portion of the loan term L. For example, time period T3 is less than the time span between a current time when the lock is placed on the digital payment asset U and the end of the loan term L. In illustration, ledger transaction controller 301 is capable of locking the digital payment asset U, which belongs to user Z, for time period T3 using the second hash H2. Ledger transaction controller 301 is capable of locking digital payment asset U on behalf of user Z for the time period T3 using the second hash H2. In an embodiment, ledger transaction controller 301 locks digital payment asset U in distributed ledger B.

Per block 408, ownership of shared digital collateral asset M is changed from users X and W to users X and Z. Accordingly, user X's consent is obtained as part of the process. The MPHTLC ensures atomicity and safety for each party involved by transferring co-ownership of the shared digital collateral asset M as described on the asset ledger against to the transfer of tokens from user Z to user W on the token ledger.

In block 409, ledger transaction controller 301 locks a pledge state of the shared digital collateral asset M using the second hash H2. For example, ledger transaction controller 301 locks the pledge state on shared digital collateral asset M with the second hash H2 for a time period T4 (e.g., a fourth predetermined time period). In an embodiment, the time period T4 is less than the time period T3. In another embodiment, time period T4 may be set equal to the time period T3/2. In block 409, the pledge state on the shared digital collateral asset M may be locked on behalf of user W to prevent further state changes until the phase of the transaction between user W and user Z is resolved or completed. Ledger transaction controller 301 is capable of locking the pledge state on shared digital collateral asset M in distributed leger A.

In block 410, ledger transaction controller 301 claims, for the first borrower (e.g., user W), the digital payment asset U using the second hash H2 prior to expiration of the time period T3. For example, ledger transaction controller 301 claims the pledge state on the shared digital collateral asset M by revealing the second secret preimage s′ prior to expiration of the time period T3. In an embodiment, ledger transaction controller 301 is capable of claiming the pledge state on behalf of user Z in block 410. Ledger transaction controller 301 is capable of claiming the pledge state on shared digital collateral asset M in distributed leger A.

In block 411, ledger transaction controller 301 claims, for the transferee (e.g., user Z), the pledge state on the shared digital collateral asset M using the second secret preimage s′. In completing block 411, the first borrower (e.g., user W) is replaced with the transferee (e.g., user Z) in the plurality of borrowers for the loan. Thus, the borrowing entity, in consequence of completing block 411, includes user X and user Z.

For example, in block 411, ledger transaction controller 301 claims digital payment asset U by supplying the second secret preimage s′ prior to the expiration of the time period T3. In an embodiment, ledger transaction controller 301 is capable of claiming the pledge state on behalf of user W. Ledger transaction controller 301 is capable of claiming digital payment asset U in distributed leger B.

In one or more embodiments, digital payment asset U may be shared by a set co-owners. A subset of those existing co-owners may be replaced with a new set of co-owners. In an embodiment, updating the borrowers during loan term L may happen multiple times. The latest set of borrowers are only considered as the eligible co-owners for the loan repayment and further collateral claim. The original borrowers (e.g., user X and user W in this example) may update to user X and user Z, where user W is replaced with user Z. Similarly, after some time within the loan term L, the current set of borrowers including user X and user Z may further update to user X and user P, where user Z is replaced with user P.

In an embodiment, multiple borrowers may try to transfer their collateral obligations simultaneously. In such a case, the borrower(s) that first submits a lock request on the pledge state of the shared digital collateral asset M wins the opportunity to implement the transfer. In an embodiment, repayment and token payment for the shared digital collateral asset M transfer may take place the same token ledger on which the loan payment occurs.

FIG. 4C is another block flow diagram depicting the operations of a third phase of the complex transaction as performed by ledger transaction controller 301 in accordance with one or more embodiments of the present invention. The third phase of the complex transaction entails implementing loan fulfillment performed across multiple distributed ledgers. In the example of FIG. 4C, the loan fulfillment is illustrated as performed after performance of FIG. 4B and occurs between what are now borrowers including user X and user Z and lender Y. It should be appreciated that in the case where FIG. 4B is not implemented, the loan fulfillment operations illustrated in FIG. 4C may be performed between user X, user W, and lender Y. That is, user W remains a borrower and user Z is not part of the transaction.

FIG. 4C illustrates operations in which the borrowers pledge the loan repayment amount (e.g., the digital repayment asset R) to the lender on a payment network and present the pledge as proof to claim of ownership of the shared digital collateral asset M. Cross-ledger data sharing with proof of ledger state authenticity is used to fetch the proof of the pledge from the payment distributed ledger and to perform the collateral claim respecting the obligations captured in the intermediate ledger state on asset distributed ledger. The lender uses the collateral claim by the borrowers as proof to claim the digital repayment asset R on the payment distributed ledger. Cross-ledger data sharing with proof of ledger state authenticity is used to fetch the proof of the collateral claim from the asset distributed ledger and perform repayment of the claim on the payment distributed ledger. Accordingly, either the lender releases the shared digital collateral asset M post expiration of the loan term L respecting the obligations captured in the intermediate ledger state on the asset distributed ledger or the shared digital collateral asset M gets transferred to the lender automatically if the borrowers fail to repay loan.

In block 412, ledger transaction controller 301 pledges a digital repayment asset R for an amount of time up to or that exceeds the loan term L. For example, the digital repayment asset R is pledged for an amount of time that extends beyond the end of the loan term L. In an embodiment, the amount of time that the digital repayment asset R is pledged may extend beyond expiration of the loan term L by a predetermined amount of time such as time period T1. That is, the digital repayment asset R may be pledged for an amount of time that ends at the expiration of an amount of time equal to time period T1 appended to the end, e.g., expiration, of the loan term L. For example, ledger transaction controller 301 is capable of pledging digital repayment asset R, which is owned by user X and user Z, from their respective account in distributed ledger C, to lender Y. In this example, ledger transaction controller 301 is capable of pledging digital repayment asset R on behalf of user X with consent obtained from user Z.

In an embodiment, ledger transaction controller 301 receives a pledge of digital repayment asset R from the borrowing entity. In an embodiment, ledger transaction controller 301 receives digital repayment asset R up to the time before the loan term expires or lapses on the token ledger. In an embodiment, ledger transaction controller 301 transfers information of the pledge of digital repayment asset R from the borrowing entity to distributed ledger C via interop-query (e.g., an interoperability query).

In block 413, ledger transaction controller 301 claims the shared digital collateral asset M by obtaining proof of the pledging of the digital repayment asset R and providing the proof prior to expiration of the loan term L. For example, ledger transaction controller 301 is capable of claiming the shared digital collateral asset M by supplying proof of the pledge on digital repayment asset R as obtained from distributed ledger C prior to expiration of the loan term L. Ledger transaction controller 301 claims the shared digital collateral asset M on behalf of user X with consent from user Z. Ledger transaction controller 301 is capable of obtaining proof from distributed ledger C and supplying the proof to distributed ledger A. In an embodiment, ledger transaction controller 301 fetches the details of the pledge on digital repayment asset R from distributed ledger C via interop-query.

In an embodiment, ledger transaction controller 301 claims the shared digital collateral asset M on the bond ledger for the borrowing entity by providing the pledge of digital repayment asset R as the proof of work. For example, the pledge of repayment amount is the proof of work. In an embodiment, the pledge of repayment amount from the token ledger is fetched by ledger transaction controller 301 via cross-chain data sharing protocol. In an embodiment, ledger transaction controller 301 claims digital repayment asset R on the token ledger, by supplying the claim of the collateral by the borrowing entity. In an embodiment, the claim of the collateral is fetched by ledger transaction controller 301 via cross-chain data sharing protocol.

In block 414, ledger transaction controller 301 claims the digital repayment asset R by providing proof the claim on the shared digital collateral asset M prior to expiration of the time period T4. For example, 301 is capable of claiming digital repayment asset R by providing proof of the claim on the shared digital collateral asset M obtained from distributed ledger A before the time period T4 expires. For example, ledger transaction controller 301 is capable of claiming the digital repayment asset R on behalf of lender Y on distributed ledger C by supplying the proof fetched from distributed ledger A. In an embodiment, ledger transaction controller 301 obtains the proof by executing an interop query and doing so prior to the expiration of the time period T4. In this example, the digital repayment asset R, which his provided prior to expiration of the loan term L, is maintained in a third distributed ledger (e.g., distributed ledger C).

Accordingly, subsequent to block 414, the loan is fulfilled with the shared digital collateral asset M being released back to the borrowing entity and lender Y having received digital repayment asset R in repayment of the loan. Typically, digital repayment asset R will be an amount greater than the loan amount N.

In an embodiment, ledger transaction controller 301 receives an indication that repayment of the loan has been satisfied or determines that repayment of the loan has been satisfied. For example, ledger transaction controller 301 receives the loan amount and interest from the borrower. In another example, ledger transaction controller 301 receives proof of work or a pledge of repayment. In another example, ledger transaction controller 301 determines the borrower satisfied the loan amount and any required interest. In an embodiment, ledger transaction controller 301 claims the collateral asset by supplying a pledge of the satisfied loan before the loan time expires. In an embodiment, ledger transaction controller 301 transfers the pledge from a first network to a second network. For example, ledger transaction controller 301 transfers the pledge on the loan amount N and interest (e.g., digital repayment asset R) from a first network to a second network in order to claim the collateral asset back for the borrowing entity. In an embodiment, ledger transaction controller 301 receives proof (p) the loan from the borrower to reclaim the collateral asset for the borrower entity. In an embodiment, ledger transaction controller 301 receives proof (p) from a different network or ledger than the network or ledger with the collateral asset. In an embodiment, ledger transaction controller 301 fetches the pledge on digital repayment asset R from a second network or ledger using any known in the field cross-network data sharing protocol that enables one network to query the state of another's ledger with proof of that state's authenticity, such as an interop-query.

In an embodiment, ledger transaction controller 301 extends the amount of time the lender Y has to access the repayment loan amount. For example, if ledger transaction controller 301 receives repayment of a loan on the last day of the loan period from the borrower, ledger transaction controller 301 extends the amount of time the lender is able to access the digital repayment asset R. In an embodiment, ledger transaction controller 301 automatically unlocks the shared digital collateral asset M for the borrowing entity when repayment of the loan before the loan term L lapses is received from the borrowing entity. In an embodiment, ledger transaction controller 301 extends the amount of time the lender has to supply the claim on the digital collateral asset by increasing the amount of time of the first predetermined time period T1 that the shared digital collateral asset M is locked with the first secret hash H1.

FIG. 4C illustrate the case in which the loan is fulfilled. In cases where the loan is not fulfilled, e.g., the borrower(s) default, the shared digital collateral asset M is released to lender Y. That is, in cases where the digital repayment asset R is not provided to lender Y prior to the expiration of the loan term, lender Y receives the shared digital collateral asset M. This may be performed by operation of a smart contract automatically.

In an embodiment, ledger transaction controller 301 determines the loan term has lapsed and the loan repayment was not satisfied. In an embodiment, in response to determining the loan period has lapsed and the loan repayment was not satisfied, ledger transaction controller 301 unlocks the shared digital collateral asset M for the lender Y to claim. In an embodiment, in response to determining ledger transaction controller 301 did not receive a pledge of the loan satisfaction before the loan period lapsed, ledger transaction controller 301 unlocks the shared digital collateral asset M for the lender Y to claim.

In an embodiment, ledger transaction controller 301 is capable of determining whether a request for a pledge of digital repayment asset R is received. In response to ledger transaction controller 301 receiving a request for a pledge of digital repayment asset R within the time constraints described herein, ledger transaction controller 301 may implement the operations illustrated in FIG. 4C. In response to ledger transaction controller 301 not receiving a pledge of digital repayment asset R within the time constraints described herein, the loan default operations may be initiated or performed.

As illustrated in the examples of FIG. 4, different operations may take place on different distributed ledgers. In an embodiment, loan repayment can take place on an additional ledger which is different from the ledgers where the shared digital collateral asset M and digital loan asset N lie, to enable the loan payment and repayment in different currencies. In an embodiment, a tri-party agreement (involving the borrowing entity and lender) lets ownership of the collateral asset switch across lenders for liquidity creation without removing the pledge on the collateral by the lender on the bond network. In an embodiment, ledger transaction controller 301 allows for loan pre-closure by the borrower with an immediate claim of the collateral on bond network. In an embodiment, ledger transaction controller 301 avoids denial of service attack launched by the lender causing the collateral asset to not be accessible to the borrower on the bond network for the loan period.

The inventive arrangements provide an atomic asset loaning protocol and an atomic asset exchange of shared assets protocol over distributed ledger(s). Within conventional distributed ledger asset exchange protocols, locks and claims are performed on asset states owned by lender(s) or borrower(s). The inventive arrangements described herein further utilize locks and claims that are placed on intermediate ledger states as part of the transactions (e.g., collateral transfer(s)). These intermediate ledger states do not represent asset states. In accordance with the inventive arrangements, loan fulfilment is halted during the update to the set of borrowers, e.g., by operation of the locks and claims on the intermediate ledger states, to ensure that no party involved is cheated by collusion attacks launched by subset of other parties involved.

In conventional asset-exchanges conducted using distributed ledgers, the asset ownership changes wholly to a new owner participating in the protocol. The inventive arrangements described herein are capable of replacing one or more (e.g., fewer than all) of the borrowers. That is, the borrowers that are part of the pledge state may be replaced partially. Thus, while a subset of the borrowers continue to be the co-owners, another subset of one or more but fewer than all of the borrows may be replaced with a new set of borrowers. The inventive arrangements are capable of securely updating the set of borrowers in the presence of collusion attacks launched by a subset of borrowers together with the lender.

As discussed and illustrated herein, the inventive arrangements support contexts involving a plurality of different distributed ledgers. For example, the loan may be issued on a first token ledger. Repayment may occur on a second token ledger. The tokens transferred to replace one or more borrowers may occur on a third token ledger. The inventive arrangements implement communication between the bond ledger and the other (e.g., three in this example) token ledgers. In the case where the borrowing entity changes during the loan term L, whether one time or multiple times, each such update may involve a different token ledger.

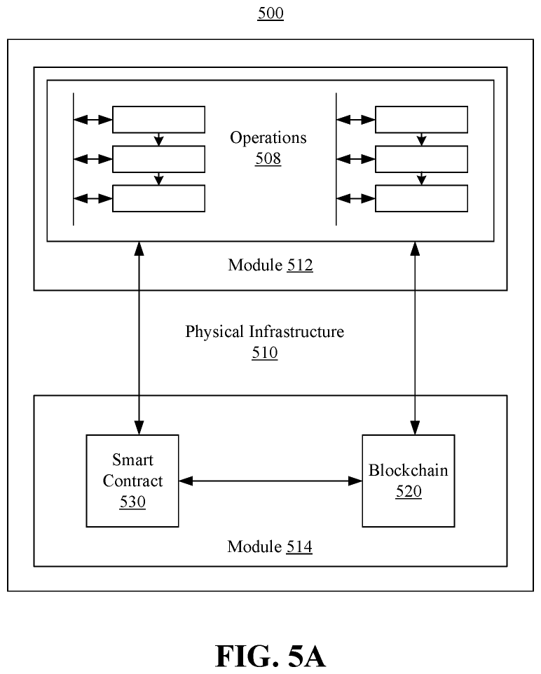

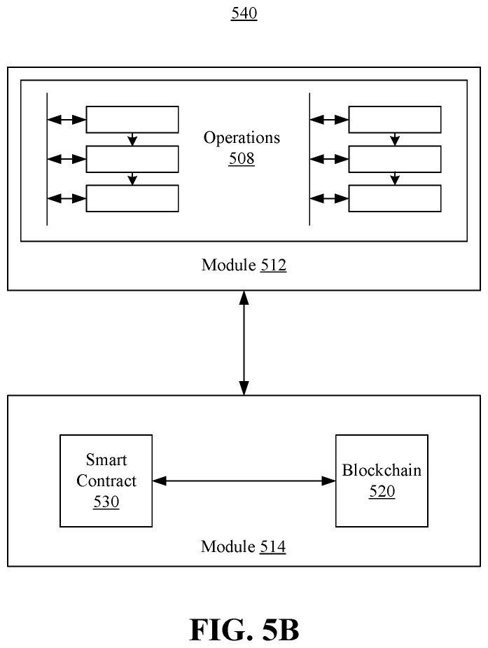

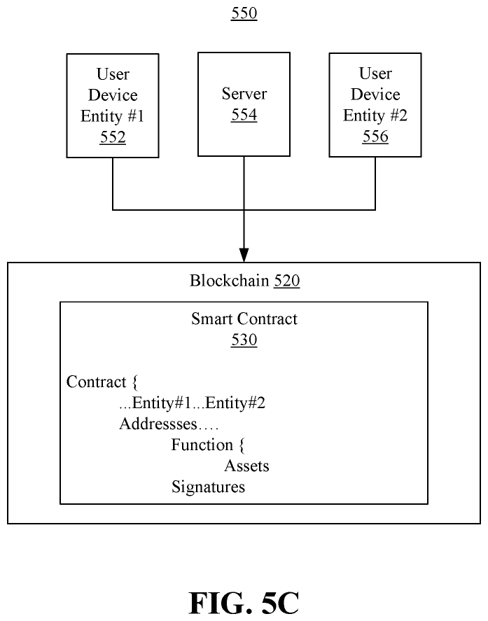

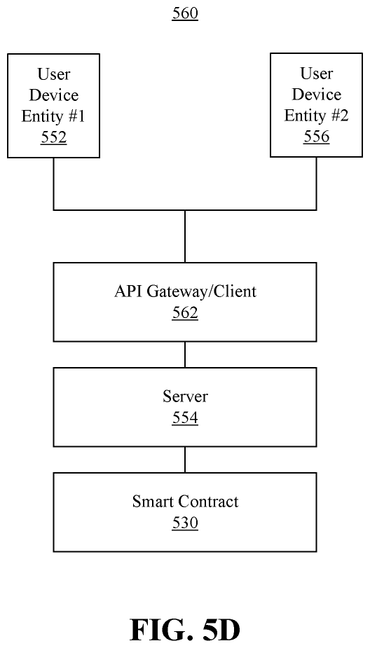

FIG. 5A illustrates an example system 500 that includes a physical infrastructure 510 configured to perform various operations in accordance with embodiments of the present disclosure. Referring to FIG. 5A, the physical infrastructure 510 includes a module 512 and a module 514. The module 514 includes a blockchain 520 and a smart contract 530 (which may reside on the blockchain 520), that may execute any of the operations 508 (in module 512) included in any of the example embodiments. The operations 508 may include one or more of the embodiments described or depicted and may represent output or written information that is written or read from one or more smart contracts 530 and/or blockchains 520. The physical infrastructure 510, the module 512, and the module 514 may include one or more computers, servers, processors, memories, and/or wireless communication devices. Further, the module 512 and the module 514 may be a same module.

FIG. 5B illustrates another example system 540 configured to perform various operations in accordance with embodiments of the present disclosure. Referring to FIG. 5B, the system 540 includes a module 512 and a module 514. The module 514 includes a blockchain 520 and a smart contract 530 (which may reside on the blockchain 520), that may execute any of the operations 508 (in module 512) included in any of the example embodiments. The operations 508 may include one or more of the embodiments described or depicted and may represent output or written information that is written or read from one or more smart contracts 530 and/or blockchains 520. The module 512 and the module 514, which may be physical modules, may include one or more computers, servers, processors, memories, and/or wireless communication devices. Further, the module 512 and the module 514 may be a same module.

FIG. 5C illustrates an example system configured to utilize a smart contract configuration among contracting parties and a mediating server configured to enforce the smart contract terms on the blockchain in accordance with embodiments of the present disclosure. Referring to FIG. 5C, the configuration 550 may represent a communication session, an asset transfer session or a process or procedure that is driven by a smart contract 530 which explicitly identifies one or more user devices 552 and/or 556. The execution, operations and results of the smart contract execution may be managed by a server 554. Content of the smart contract 530 may require digital signatures by one or more of the entities 552 and 556 which are parties to the smart contract transaction. The results of the smart contract execution may be written to a blockchain 520 as a blockchain transaction. The smart contract 530 resides on the blockchain 520 which may reside on one or more computers, servers, processors, memories, and/or wireless communication devices.

FIG. 5D illustrates a system 560 including a blockchain, in accordance with embodiments of the present disclosure. Referring to the example of FIG. 5D, an application programming interface (API) gateway 562 provides a common interface for accessing blockchain logic (e.g., smart contract 530 or other chaincode) and data (e.g., distributed ledger, etc.). In this example, the API gateway 562 is a common interface for performing transactions (e.g., invoke, queries, etc.) on the blockchain by connecting one or more entities, e.g., clients 552 and 556, to a blockchain peer (e.g., server 554). Here, the server 554 is a blockchain network peer component that holds a copy of the world state and a distributed ledger allowing clients 552 and 556 to query data on the world state as well as submit transactions into the blockchain network where, depending on the smart contract 530 and license terms, authorized transactions will run the smart contract 530.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An example storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

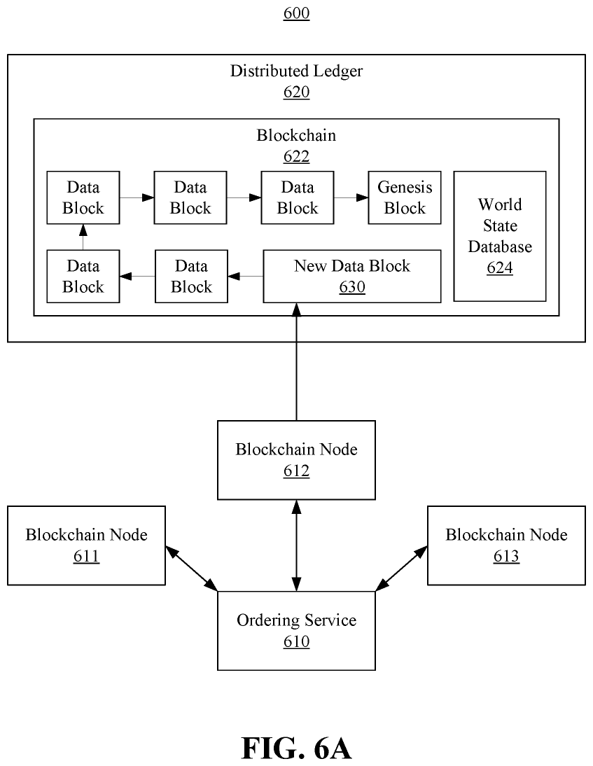

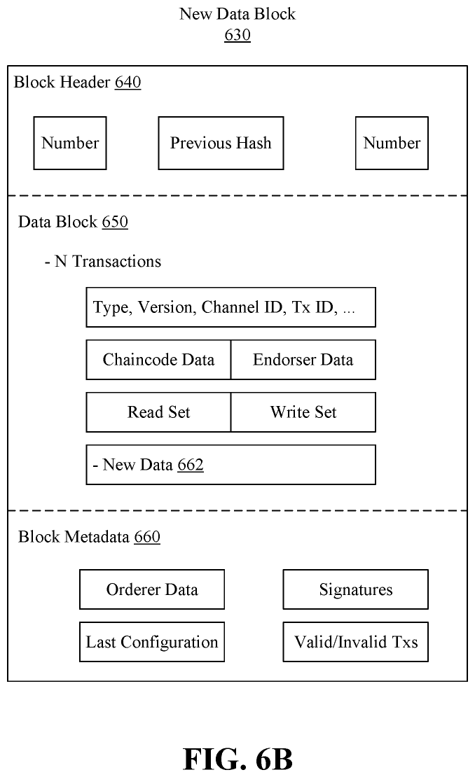

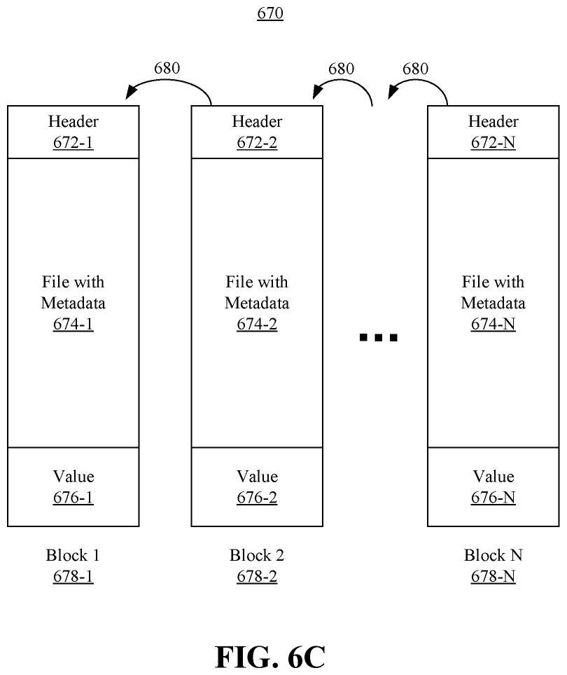

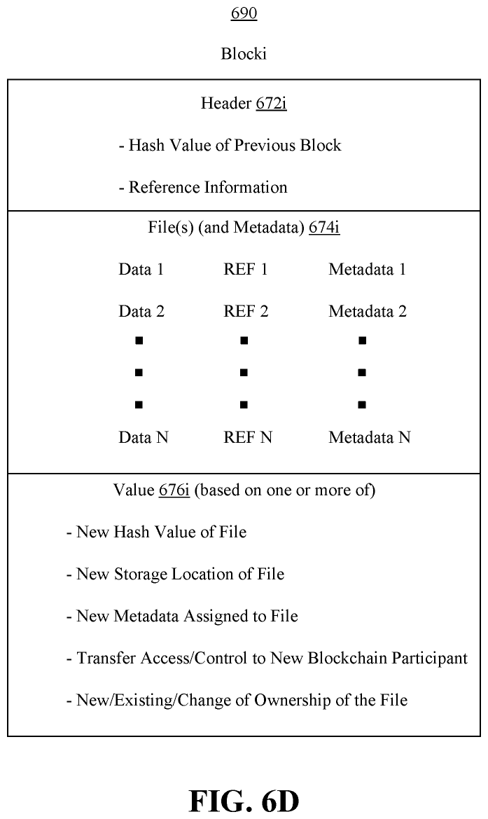

FIG. 6A illustrates a process 600 of a new block being added to a distributed ledger 620, in accordance with embodiments of the present disclosure (e.g., when a new smart contract is generated, etc.), and FIG. 6A illustrates contents of a new data block 630 for blockchain, in accordance with embodiments of the present disclosure. The new data block 630 may contain document linking data.

Referring to FIG. 6A, clients (not shown) may submit transactions to blockchain nodes 611, 612, and/or 613. Clients may be instructions received from any source to enact activity on the blockchain 622. As an example, clients may be applications that act on behalf of a requester, such as a device, person or entity to propose transactions for the blockchain. The plurality of blockchain peers (e.g., blockchain nodes 611, 612, and/or 613) may maintain a state of the blockchain network and a copy of the distributed ledger 620. Different types of blockchain nodes/peers may be present in the blockchain network including nodes which simulate and authorize transactions proposed by clients; recommending nodes which utilize natural language processing techniques and recommend entities to be automatically contracted with users; and committing peers which validate transactions and commit transactions to the distributed ledger 620. In this example, the blockchain nodes 611, 612, and/or 613 may perform the role of endorser node, committer node, recommender node, or all three.

The distributed ledger 620 includes a blockchain 622 which stores immutable, sequenced records in blocks, and a state database 624 (current world state) maintaining a current state of the blockchain 622. One distributed ledger 620 may exist per channel and each peer maintains its own copy of the distributed ledger 620 for each channel of which they are a member. The blockchain 622 is a transaction log, structured as hash-linked blocks where each block contains a sequence of N transactions. Blocks may include various components such as shown in FIG. 6A. The linking of the blocks (shown by arrows in FIG. 6A) may be generated by adding a hash of a prior block's header within a block header of a current block. In this way, all transactions on the blockchain 622 are sequenced and cryptographically linked together preventing tampering with blockchain data without breaking the hash links. Furthermore, because of the links, the latest block in the blockchain 622 represents every transaction that has come before it. The blockchain 622 may be stored on a peer file system (local or attached storage), which supports an append-only blockchain workload.

The current state of the blockchain 622 and the distributed ledger 620 may be stored in the state database 624. Here, the current state data represents the latest values for all keys ever included in the chain transaction log of the blockchain 622. Chaincode invocations execute transactions against the current state in the state database 624. To make these chaincode interactions extremely efficient, the latest values of all keys are stored in the state database 624. The state database 624 may include an indexed view into the transaction log of the blockchain 622, it can therefore be regenerated from the chain at any time. The state database 624 may automatically get recovered (or generated if needed) upon peer startup, before transactions are accepted.

Nodes receive transactions from clients and authorize the transaction based on simulated results. Nodes hold smart contracts which simulate the transaction proposals. When a node authorizes a transaction, the node creates a transaction endorsement which is a signed response from the node to the client application indicating the authorization transaction. The method of securing a digital asset may be specified within chaincode. Different channels may have different licensing terms. Authorized transactions are forward by the client application to ordering service 610.

The ordering service 610 accepts authorized transactions, orders them into a block, and delivers the blocks to the committing peers. For example, the ordering service 610 may initiate a new block when a threshold of transactions has been reached, a timer times out, or another condition. In the example of FIG. 6A, blockchain node 612 is a committing peer that has received a new data block 630 for storage on blockchain 622. The first block in the blockchain may be referred to as a genesis block which includes information about the blockchain, its members, the data stored therein, etc.

The ordering service 610 may be made up of a cluster of orderers. The ordering service 610 does not process transactions, smart contracts, or maintain the shared ledger. Rather, the ordering service 610 may accept the authorized transactions and specifies the order in which those transactions are committed to the distributed ledger 620. The architecture of the blockchain network may be designed such that the specific implementation of ‘ordering’ becomes a pluggable component.

Transactions are written to the distributed ledger 620 in a consistent order. The order of transactions is established to ensure that the updates to the state database 624 are valid when they are committed to the network. Unlike a cryptocurrency blockchain system where ordering occurs through the solving of a cryptographic puzzle, or mining, in this example the parties of the distributed ledger 620 may choose the ordering mechanism that best suits that network.

When the ordering service 610 initializes a new data block 630, the new data block 630 may be broadcast to committing peers (e.g., blockchain nodes 611, 612, and 613). When the transaction is authorized, the transaction is written to the blockchain 622 on the distributed ledger 620, and the state database 624 is updated with the write data from the read-write set. If a transaction fails, that is, if the committing peer finds that the read-write set does not match the current world state in the state database 624, the transaction ordered into a block will still be included in that block, but it will be marked as invalid, and the state database 624 will not be updated.

Referring to FIG. 6B, a new data block 630 (also referred to as a data block) that is stored on the blockchain 622 of the distributed ledger 620 may include multiple data segments such as a block header 640, data block 650, and block metadata 660. It should be appreciated that the various depicted blocks and their contents, such as new data block 630 and its contents shown in FIG. 6B are merely examples and are not meant to limit the scope of the example embodiments. The new data block 630 may store transactional information of N transaction(s) (e.g., 1, 10, 100, 500, 1000, 2000, 3000, etc.) within the data block 650. The new data block 630 may also include a link to a previous block (e.g., on the blockchain 622 in FIG. 6A) within the block header 640. In particular, the block header 640 may include a hash of a previous block's header. The block header 640 may also include a unique block number, a hash of the data block 650 of the new data block 630, and the like. The block number of the new data block 630 may be unique and assigned in various orders, such as an incremental/sequential order starting from zero.

The data block 650 may store transactional information of each transaction that is recorded within the new data block 630. For example, the transaction data may include one or more of a type of the transaction, a version, a timestamp, a channel ID of the distributed ledger 620, a transaction ID, an epoch, a payload visibility, a chaincode path (deploy tx), a chaincode name, a chaincode version, input (chaincode and functions), a client (creator) identify such as a public key and certificate, a signature of the client, signature of licensor, identities of licensors, a proposal hash, chaincode events, response status, namespace, a read set (list of key and version read by the transaction, etc.), a write set (list of key and value, etc.), a start key, an end key, a list of keys, a Merkle tree query summary, and the like. The transaction data may be stored for each of the N transactions.

In some embodiments, the data block 650 may also store new data 662 which adds additional information to the hash-linked chain of blocks in the blockchain 622. The additional information includes one or more of the steps, features, processes and/or actions described or depicted herein. Accordingly, the new data 662 can be stored in an immutable log of blocks on the distributed ledger 620. Some of the benefits of storing such new data 662 are reflected in the various embodiments disclosed and depicted herein. Although in FIG. 6B the new data 662 is depicted in the data block 650 but could also be located in the block header 640 or the block metadata 660. The new data 662 may include a document composite key that is used for linking the documents within an organization.

The block metadata 660 may store multiple fields of metadata (e.g., as a byte array, etc.). Metadata fields may include signature on block creation, a reference to a last configuration block, a transaction filter identifying valid and invalid transactions within the block, last offset persisted of an ordering service that ordered the block, and the like. The signature, the last configuration block, and the ordered metadata may be added by the ordering service 610. Meanwhile, a committer of the block (such as blockchain node 612) may add validity/invalidity information based on an endorsement policy, verification of read/write sets, and the like. The transaction filter may include a byte array of a size equal to the number of transactions in the data block 650 and a validation code identifying whether a transaction was valid/invalid.

FIG. 6C illustrates an embodiment of a blockchain 670 for digital content in accordance with the embodiments described herein. The digital content may include one or more files and associated information. The files may include media, images, video, audio, text, links, graphics, animations, web pages, documents, or other forms of digital content. The immutable, append-only aspects of the blockchain serve as a safeguard to protect the integrity, validity, and authenticity of the digital content, making it suitable use in legal proceedings where admissibility rules apply or other settings where evidence is taken into consideration or where the presentation and use of digital information is otherwise of interest. In this case, the digital content may be referred to as digital evidence.

The blockchain may be formed in various ways. In one embodiment, the digital content may be included in and accessed from the blockchain itself. For example, each block of the blockchain may store a hash value of reference information (e.g., header, value, etc.) along the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:
Block 1 Block 2 . . . Block N
Hash Value 1 Hash Value 2 Hash Value N
Digital Content 1 Digital Content 2 Digital Content N

In one embodiment, the digital content may not be included in the blockchain. For example, the blockchain may store the encrypted hashes of the content of each block without any of the digital content. The digital content may be stored in another storage area or memory address in association with the hash value of the original file. The other storage area may be the same storage device used to store the blockchain or may be a different storage area or even a separate relational database. The digital content of each block may be referenced or accessed by obtaining or querying the hash value of a block of interest and then looking up that value in the storage area, which is stored in correspondence with the actual digital content. This operation may be performed, for example, by a database gatekeeper. This may be illustrated as follows:

| Blockchain | Storage Area |
|---|---|
| Block 1 Hash Value | Block 1 Hash Value . . . Content |
| . | . |
| . | . |
| . | . |
| Block N Hash Value | Block N Hash Value . . . Content |

In the example embodiment of FIG. 6C, the blockchain 670 includes a number of blocks 678-1, 678-2, . . . 678-N cryptographically linked in an ordered sequence, where N>1. The encryption used to link the blocks 678-1, 678-2, . . . 678-N may be any of a number of keyed or un-keyed Hash functions. In one embodiment, the blocks 678-1, 678-2, . . . 678-N are subject to a hash function which produces n-bit alphanumeric outputs (where n is 256 or another number) from inputs that are based on information in the blocks. Examples of such a hash function include, but are not limited to, a SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In another embodiment, the blocks 678-1, 678-2, . . . , 678-N may be cryptographically linked by a function that is different from a hash function. For purposes of illustration, the following description is made with reference to a hash function, e.g., SHA-2.

Each of the blocks 678-1, 678-2, . . . , 678-N in the blockchain includes a header, aversion of the file, and a value. The header and the value are different for each block as a result of hashing in the blockchain. In one embodiment, the value may be included in the header. As described in greater detail below, the version of the file may be the original file or a different version of the original file.

The first block 678-1 in the blockchain is referred to as the genesis block and includes the header 672-1, original file 674-1, and an initial value 676-1. The hashing scheme used for the genesis block, and indeed in all subsequent blocks, may vary. For example, all the information in the first block 678-1 may be hashed together and at one time, or each or a portion of the information in the first block 678-1 may be separately hashed and then a hash of the separately hashed portions may be performed.

The header 672-1 may include one or more initial parameters, which, for example, may include a version number, timestamp, nonce, root information, difficulty level, consensus protocol, duration, media format, source, descriptive keywords, and/or other information associated with original file 674-1 and/or the blockchain. The header 672-1 may be generated automatically (e.g., by blockchain network managing software) or manually by a blockchain participant. Unlike the header in other blocks 678-2 to 678-N in the blockchain, the header 672-1 in the genesis block does not reference a previous block, simply because there is no previous block.

The original file 674-1 in the genesis block may be, for example, data as captured by a device with or without processing prior to its inclusion in the blockchain. The original file 674-1 is received through the interface of the system from the device, media source, or node. The original file 674-1 is associated with metadata, which, for example, may be generated by a user, the device, and/or the system processor, either manually or automatically. The metadata may be included in the first block 678-1 in association with the original file 674-1.

The value 676-1 in the genesis block is an initial value generated based on one or more unique attributes of the original file 674-1. In one embodiment, the one or more unique attributes may include the hash value for the original file 674-1, metadata for the original file 674-1, and other information associated with the file. In one implementation, the initial value 676-1 may be based on the following unique attributes: 1) SHA-2 computed hash value for the original file; 2) originating device ID; 3) starting timestamp for the original file; 4) initial storage location of the original file; and 5) blockchain network member ID for software to currently control the original file and associated metadata.

The other blocks 678-2 to 678-N in the blockchain also have headers, files, and values. However, unlike the first header 672-1, each of the headers 672-2 to 672-N in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 680, to establish an auditable and immutable chain-of-custody.

Each of the header 672-2 to 672-N in the other blocks may also include other information, e.g., version number, timestamp, nonce, root information, difficulty level, consensus protocol, and/or other parameters or information associated with the corresponding files and/or the blockchain in general.

The files 674-2 to 674-N in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing which involves analyzing a file may include, for example, appending, including, or otherwise associating various analytics, statistics, or other information associated with the file.

The values in each of the other blocks 676-2 to 676-N in the other blocks are unique values and are all different as a result of the processing performed. For example, the value in any one block corresponds to an updated version of the value in the previous block. The update is reflected in the hash of the block to which the value is assigned. The values of the blocks therefore provide an indication of what processing was performed in the blocks and also permit a tracing through the blockchain back to the original file. This tracking confirms the chain-of-custody of the file throughout the entire blockchain.

For example, consider the case where portions of the file in a previous block are redacted, blocked out, or pixelated in order to protect the identity of a person shown in the file. In this case, the block including the redacted file will include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In one embodiment, the value of a previous block may be updated (e.g., a new hash value computed) to form the value of a current block when any one or more of the following occurs. The new hash value may be computed by hashing all or a portion of the information noted below, in this example embodiment,
a) new SHA-2 computed hash value if the file has been processed in any way (e.g., if the file was redacted, copied, altered, accessed, or some other action was taken)
b) new storage location for the file
c) new metadata identified associated with the file
d) transfer of access or control of the file from one blockchain participant to another blockchain participant

FIG. 6D illustrates an embodiment of a block which may represent the structure of the blocks in the blockchain 690 in accordance with one embodiment. The block, Blocki, includes a header 672i, a file 674i, and a value 676i.

The header 672i includes a hash value of a previous block Blocki−1 and additional reference information, which, for example, may be any of the types of information (e.g., header information including references, characteristics, parameters, etc.) discussed herein. All blocks reference the hash of a previous block except, of course, the genesis block. The hash value of the previous block may be just a hash of the header in the previous block or a hash of all or a portion of the information in the previous block, including the file and metadata.

The file 674i includes a plurality of data, such as Data 1, Data 2, . . . , Data N in sequence. The data are tagged with Metadata 1, Metadata 2, . . . , Metadata N which describe the content and/or characteristics associated with the data. For example, the metadata for each data may include information to indicate a timestamp for the data, process the data, keywords indicating the persons or other content depicted in the data, and/or other features that may be helpful to establish the validity and content of the file as a whole, and particularly its use as digital evidence, for example, as described in connection with an embodiment discussed below. In addition to the metadata, each data may be tagged with reference REF 1, REF 2, . . . , REF N to a previous data to prevent tampering, gaps in the file, and sequential reference through the file.

Once the metadata is assigned to the data (e.g., through a smart contract), the metadata cannot be altered without the hash changing, which can easily be identified for invalidation. The metadata, thus, creates a data log of information that may be accessed for use by participants in the blockchain.

The value 676i is a hash value or other value computed based on any of the types of information previously discussed. For example, for any given block Blocki, the value for that block may be updated to reflect the processing that was performed for that block, e.g., new hash value, new storage location, new metadata for the associated file, transfer of control or access, identifier, or other action or information to be added. Although the value in each block is shown to be separate from the metadata for the data of the file and header, the value may be based, in part or whole, on this metadata in another embodiment.

Once the blockchain 690 is formed, at any point in time, the immutable chain-of-custody for the file may be obtained by querying the blockchain for the transaction history of the values across the blocks. This query, or tracking procedure, may begin with decrypting the value of the block that is most currently included (e.g., the last (Nth) block), and then continuing to decrypt the value of the other blocks until the genesis block is reached and the original file is recovered. The decryption may involve decrypting the headers and files and associated metadata at each block, as well.

Decryption is performed based on the type of encryption that took place in each block. This may involve the use of private keys, public keys, or a public key-private key pair. For example, when asymmetric encryption is used, blockchain participants or a processor in the network may generate a public key and private key pair using a predetermined algorithm. The public key and private key are associated with each other through some mathematical relationship. The public key may be distributed publicly to serve as an address to receive messages from other users, e.g., an IP address or home address. The private key is kept secret and used to digitally sign messages sent to other blockchain participants. The signature is included in the message so that the recipient can verify using the public key of the sender. This way, the recipient can be sure that only the sender could have sent this message.

Generating a key pair may be analogous to creating an account on the blockchain, but without having to actually register anywhere. Also, every transaction that is executed on the blockchain is digitally signed by the sender using their private key. This signature ensures that only the owner of the account can track and process (if within the scope of permission determined by a smart contract) the file of the blockchain.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for automatically and digitally securing an asset, the computer-implemented method comprising:
locking a shared digital collateral asset with a first hash for a first predetermined time period, wherein the shared digital collateral asset is owned by a plurality of borrowers, and wherein the first hash is generated by hashing a plurality of secrets corresponding to the plurality of borrowers;
locking a digital loan asset with the first hash for a second predetermined time period, wherein the second predetermined time period is less than the first predetermined time period;
releasing the digital loan asset to the plurality of borrowers in response to receiving a first secret preimage prior to expiration of the second predetermined time period, wherein the first secret preimage is generated using the plurality of secrets; and
prior to expiration of the first predetermined time period, claiming the shared digital collateral asset using the first secret preimage and pledging the shared digital collateral asset for a loan term.

2. The computer-implemented method of claim 1, further comprising transferring an interest in the shared digital collateral asset from a first borrower of the plurality of borrowers to a transferee, the transferring including:
locking, for a third predetermined time period, a digital payment asset of the transferee using a second hash, wherein the second hash is generated using a second secret preimage from the first borrower and the third predetermined time period is less than a remaining portion of the loan term;
locking a pledge state of the shared digital collateral asset using the second hash;
claiming, for the first borrower, the digital payment asset using the second hash prior to expiration of the third predetermined time period; and
claiming, for the transferee, the pledge state on the shared digital collateral asset using the second secret preimage, wherein the first borrower is replaced with the transferee in the plurality of borrowers.

3. The computer-implemented method of claim 2, further comprising:
pledging a digital repayment asset for an amount of time that exceeds the loan term;
claiming the shared digital collateral asset by obtaining proof of the pledging of the digital repayment asset and providing the proof prior to expiration of the loan term; and
claiming the digital repayment asset by providing proof the claim on the shared digital collateral asset prior to expiration of a fourth predetermined time period.

4. The computer-implemented method of claim 1, further comprising:
pledging a digital repayment asset for an amount of time that exceeds the loan term;
claiming the shared digital collateral asset by obtaining proof of the pledging of the digital repayment asset and providing the proof prior to expiration of the loan term; and
claiming the digital repayment asset by providing proof the claim on the shared digital collateral asset prior to expiration of a fourth predetermined time period.

5. The computer-implemented method of claim 1, wherein the digital loan asset is maintained in a first distributed ledger and the shared digital collateral asset is maintained in a second distributed ledger.

6. The computer-implemented method of claim 5, wherein a digital repayment asset provided prior to expiration of the loan term is maintained in a third distributed ledger.

7. The computer-implemented method of claim 1, further comprising:
in response to expiration of the loan term, the shared digital collateral asset is automatically freed from the pledging.

8. A system for automatically and digitally securing an asset, the system comprising:
one or more processors configured to execute operations including:
locking a shared digital collateral asset with a first hash for a first predetermined time period, wherein the shared digital collateral asset is owned by a plurality of borrowers, and wherein the first hash is generated by hashing a plurality of secrets corresponding to the plurality of borrowers;
locking a digital loan asset with the first hash for a second predetermined time period, wherein the second predetermined time period is less than the first predetermined time period;
releasing the digital loan asset to the plurality of borrowers in response to receiving a first secret preimage prior to expiration of the second predetermined time period, wherein the first secret preimage is generated using the plurality of secrets; and
prior to expiration of the first predetermined time period, claiming the shared digital collateral asset using the first secret preimage and pledging the shared digital collateral asset for a loan term.

9. The system of claim 8, wherein the one or more processors are configured to execute operations further comprising transferring an interest in the shared digital collateral asset from a first borrower of the plurality of borrowers to a transferee, the transferring including:
locking, for a third predetermined time period, a digital payment asset of the transferee using a second hash, wherein the second hash is generated using a second secret preimage from the first borrower and the third predetermined time period is less than a remaining portion of the loan term;
locking a pledge state of the shared digital collateral asset using the second hash;
claiming, for the first borrower, the digital payment asset using the second hash prior to expiration of the third predetermined time period; and
claiming, for the transferee, the pledge state on the shared digital collateral asset using the second secret preimage, wherein the first borrower is replaced with the transferee in the plurality of borrowers.

10. The system of claim 9, wherein the one or more processors are configured to execute operations further comprising:
pledging a digital repayment asset for an amount of time that exceeds the loan term;
claiming the shared digital collateral asset by obtaining proof of the pledging of the digital repayment asset and providing the proof prior to expiration of the loan term; and
claiming the digital repayment asset by providing proof the claim on the shared digital collateral asset prior to expiration of a fourth predetermined time period.

11. The system of claim 8, wherein the one or more processors are configured to execute operations further comprising:
pledging a digital repayment asset for an amount of time that exceeds the loan term;
claiming the shared digital collateral asset by obtaining proof of the pledging of the digital repayment asset and providing the proof prior to expiration of the loan term; and
claiming the digital repayment asset by providing proof the claim on the shared digital collateral asset prior to expiration of a fourth predetermined time period.

12. The system of claim 8, wherein the digital loan asset is maintained in a first distributed ledger and the shared digital collateral asset is maintained in a second distributed ledger.

13. The system of claim 12, wherein a digital repayment asset provided prior to expiration of the loan term is maintained in a third distributed ledger.

14. The system of claim 8, wherein the one or more processors are configured to execute operations further comprising:
in response to expiration of the loan term, the shared digital collateral asset is automatically freed from the pledging.

15. A computer program product comprising one or more computer readable storage mediums having program instructions embodied therewith, wherein the program instructions are executable by one or more processors to cause the one or more processors to execute operations comprising:
locking a shared digital collateral asset with a first hash for a first predetermined time period, wherein the shared digital collateral asset is owned by a plurality of borrowers, and wherein the first hash is generated by hashing a plurality of secrets corresponding to the plurality of borrowers;
locking a digital loan asset with the first hash for a second predetermined time period, wherein the second predetermined time period is less than the first predetermined time period;
releasing the digital loan asset to the plurality of borrowers in response to receiving a first secret preimage prior to expiration of the second predetermined time period, wherein the first secret preimage is generated using the plurality of secrets; and
prior to expiration of the first predetermined time period, claiming the shared digital collateral asset using the first secret preimage and pledging the shared digital collateral asset for a loan term.

16. The computer program product of claim 15, wherein the program instructions are executable by the one or more processors to cause the one or more processors to execute an operation including transferring an interest in the shared digital collateral asset from a first borrower of the plurality of borrowers to a transferee, the transferring including:
locking, for a third predetermined time period, a digital payment asset of the transferee using a second hash, wherein the second hash is generated using a second secret preimage from the first borrower and the third predetermined time period is less than a remaining portion of the loan term;
locking a pledge state of the shared digital collateral asset using the second hash;
claiming, for the first borrower, the digital payment asset using the second hash prior to expiration of the third predetermined time period; and
claiming, for the transferee, the pledge state on the shared digital collateral asset using the second secret preimage, wherein the first borrower is replaced with the transferee in the plurality of borrowers.

17. The computer program product of claim 16, wherein the program instructions are executable by one or more processors to cause the one or more processors to execute operations comprising:
pledging a digital repayment asset for an amount of time that exceeds the loan term;
claiming the shared digital collateral asset by obtaining proof of the pledging of the digital repayment asset and providing the proof prior to expiration of the loan term; and
claiming the digital repayment asset by providing proof the claim on the shared digital collateral asset prior to expiration of a fourth predetermined time period.

18. The computer program product of claim 15, wherein the program instructions are executable by one or more processors to cause the one or more processors to execute operations comprising:
pledging a digital repayment asset for an amount of time that exceeds the loan term;
claiming the shared digital collateral asset by obtaining proof of the pledging of the digital repayment asset and providing the proof prior to expiration of the loan term; and
claiming the digital repayment asset by providing proof the claim on the shared digital collateral asset prior to expiration of a fourth predetermined time period.

19. The compute program product of claim 15, wherein the digital loan asset is maintained in a first distributed ledger and the shared digital collateral asset is maintained in a second distributed ledger.

20. The compute program product of claim 19, wherein a digital repayment asset provided prior to expiration of the loan term is maintained in a third distributed ledger.
